(19) United States
(12) Patent Application Publication
(10) Pub. No.: US 2026/0299259 A1
(43) Pub. Date: Oct. 1, 2026

(54) OPTICAL IMAGING SYSTEM

(71) Applicant: Samsung Electro-Mechanics Co., Ltd., Suwon-si (KR)

(72) Inventors: Kum Ho KIM, Suwon-si (KR); Dong Hyuk JANG, Suwon-si (KR); Chang Kyun HA, Suwon-si (KR); Sun Woo KIM, Suwon-si (KR)

(73) Assignee: Samsung Electro-Mechanics Co., Ltd., Suwon-si (KR)

(21) Appl. No.: 19/549,700

(22) Filed: Feb. 25, 2026

(30) Foreign Application Priority Data
Mar. 28, 2025 (KR) 10-2025-0040142

(51) Int. Cl. G02B 13/00; G02B 9/64

(52) U.S. Cl. CPC G02B 13/0045; G02B 9/64

(57) ABSTRACT

An optical imaging system includes a first lens having a positive refractive power, a second lens having a negative refractive power, a third lens having a refractive power, a fourth lens having a positive refractive power, a fifth lens having a negative refractive power, a sixth lens having a refractive power, a seventh lens having a refractive power, an eighth lens having a refractive power, and a ninth lens having a refractive power, wherein the first to ninth lenses are sequentially disposed along an optical axis from an object side, and the optical imaging system satisfies 0.9<(TTL/(2×IMG HT))×Fno≤0.95, where TTL is a distance along the optical axis from an object-side surface of the first lens to an imaging plane, IMG HT is one half of a diagonal length of the imaging plane, and Fno is an F-number of the optical imaging system.

### CROSS-REFERENCE TO RELATED APPLICATIONS

This application claims the benefit under 35 USC 119(a) of Korean Patent Application No. 10-2025-0040142 filed on Mar. 28, 2025, in the Korean Intellectual Property Office, the entire disclosure of which is incorporated herein by reference for all purposes.

### TECHNICAL FIELD

### 1. Field

The present disclosure relates to an optical imaging system.

### 2. Description of Background

Recent mobile devices are equipped with camera modules that incorporate optical imaging systems comprised of multiple lenses, enabling video calls and photography.

As the functionality of camera modules in mobile devices continues to expand, demand for high-resolution camera modules for mobile devices is increasing.

Furthermore, as mobile devices become increasingly smaller, demand for slimmer mobile device camera modules is also increasing. Consequently, the development of optical imaging systems capable of obtaining a high resolution while remaining slim is ongoing.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens having a positive refractive power; a second lens having a negative refractive power; a third lens having a refractive power; a fourth lens having a positive refractive power; a fifth lens having a negative refractive power; a sixth lens having a refractive power; a seventh lens having a refractive power; an eighth lens having a refractive power; and a ninth lens having a refractive power, wherein the first to ninth lenses are sequentially disposed in ascending numerical order along an optical axis of the optical imaging system from an object side of the optical imaging system toward an imaging plane of the optical imaging system, and the optical imaging system may satisfy 0.9<(TTL/(2×IMG HT))×Fno≤0.95, where TTL is a distance along the optical axis from an object-side surface of the first lens to the imaging plane, IMG HT is one half of a diagonal length of the imaging plane, and Fno is an F-number of the optical imaging system.

A combined focal length of the second and third lenses may have a negative value, and the second and third lenses may each have an Abbe number less than 21.

The optical imaging system may satisfy 0.67<TTL/(2×IMG HT)<0.73.

The optical imaging system may satisfy 1.25<Fno<1.35.

The optical imaging system may satisfy 0<f1/f<1, where f is a total focal length of the optical imaging system, and f1 is a focal length of the first lens.

The optical imaging system may satisfy −1<f1/f2<0, where f1 is a focal length of the first lens, and f2 is a focal length of the second lens.

The optical imaging system may satisfy −1<f1/f3<1, where f1 is a focal length of the first lens, and f3 is a focal length of the third lens.

The optical imaging system may satisfy −2.6<f23/f1<−2.00, where f23 is a combined focal length of the second and third lenses, and f1 is a focal length of the first lens.

The optical imaging system may satisfy 0.89<f23/f2<1.10, where f23 is a combined focal length of the second and third lenses, and f2 is a focal length of the second lens.

The optical imaging system may satisfy 1.20<TTL/f<1.35 and 0<BFL/f<0.2, where f is a total focal length of the optical imaging system, and BFL is a distance along the optical axis from an image-side surface of the ninth lens to the imaging plane.

The optical imaging system may satisfy 70°<FOV×(IMG HT/f)<80°, where FOV is a field of view of the optical imaging system, and f is a total focal length of the optical imaging system.

The optical imaging system may satisfy either one or both of 25<v1−v2<40 and −10<v3−v2<10, where v1 is an Abbe number of the first lens, v2 is an Abbe number of the second lens, and v3 is an Abbe number of the third lens.

The optical imaging system may satisfy 15<v1−(v5+v6)/2<40, where v1 is an Abbe number of the first lens, v5 is an Abbe number of the fifth lens, and v6 is an Abbe number of the sixth lens.

Each of the first to third lenses may have a convex object-side surface in a paraxial region thereof, and a concave image-side surface in a paraxial region thereof.

The sixth lens may have a negative refractive power, the seventh lens may have a positive refractive power, and a combined focal length of the sixth and seventh lenses may have a negative value.

The sixth lens may have a concave image-side surface in a paraxial region thereof, and the seventh lens may have a convex object-side surface in a paraxial region thereof.

The sixth lens may have a negative refractive power.

The seventh lens has a positive refractive power.

The eighth lens may have a positive refractive power.

The ninth lens may have a negative refractive power.

Other features and aspects will be apparent from the following detailed description, the drawings, and the claims.

### BRIEF DESCRIPTION OF DRAWINGS

FIG. 1 is a diagram of a configuration of an optical imaging system according to a first embodiment.

FIG. 2 is graphs illustrating aberration characteristics of the optical imaging system illustrated in FIG. 1.

FIG. 3 is a diagram of a configuration of an optical imaging system according to a second embodiment.

FIG. 4 is graphs illustrating aberration characteristics of the optical imaging system illustrated in FIG. 3.

FIG. 5 is a diagram of a configuration of an optical imaging system according to a third embodiment.

FIG. 6 is graphs illustrating aberration characteristics of the optical imaging system illustrated in FIG. 5.

FIG. 7 is a diagram of a configuration of an optical imaging system according to a fourth embodiment.

FIG. 8 is graphs illustrating aberration characteristics of the optical imaging system illustrated in FIG. 7.

FIG. 9 is a diagram of a configuration of an optical imaging system according to a fifth embodiment.

FIG. 10 is graphs illustrating aberration characteristics of the optical imaging system illustrated in FIG. 9.

FIG. 11 is a diagram of a configuration of an optical imaging system according to a sixth embodiment.

FIG. 12 is graphs illustrating aberration characteristics of the optical imaging system illustrated in FIG. 11.

FIG. 13 is a diagram of a configuration of an optical imaging system according to a seventh embodiment.

FIG. 14 is graphs illustrating aberration characteristics of the optical imaging system illustrated in FIG. 13.

FIG. 15 is a diagram of a configuration of an optical imaging system according to an eighth embodiment.

FIG. 16 is graphs illustrating aberration characteristics of the optical imaging system illustrated in FIG. 15.

FIG. 17 is a diagram of a configuration of an optical imaging system according to a ninth embodiment.

FIG. 18 is graphs illustrating aberration characteristics of the optical imaging system illustrated in FIG. 17.

FIG. 19 is a diagram of a configuration of an optical imaging system according to a tenth embodiment.

FIG. 20 is graphs illustrating aberration characteristics of the optical imaging system illustrated in FIG. 19.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In the lens configuration diagrams below, the thickness, size, and shape of the lenses are somewhat exaggerated for illustration. In particular, the spherical or aspherical shapes illustrated in the lens configuration diagrams are provided as examples and are not limited to these shapes.

An optical imaging system according to an embodiment includes nine lenses.

A first lens is a lens closest to an object side of the optical imaging system, and a ninth lens is a lens closest to an imaging plane (or an image sensor) of the optical imaging system.

In this specification, radiuses of curvature, thickness, distance, focal length, and other dimensions are expressed in millimeters (mm), and a field of view (FOV) is expressed in degrees) (°.

In addition, in a description of a shape of a lens, a statement that a surface of a lens is convex means that a paraxial region of the surface is convex, and a statement that a surface of a lens is concave means that a paraxial region of the surface is concave. Accordingly, even when it is stated that a surface of a lens is convex, an edge portion of the surface of the lens may be concave. Similarly, even when it is stated that a surface of a lens is concave, an edge portion of the surface of the lens may be convex.

A paraxial region of a lens surface is a very narrow region around an optical axis of the lens surface.

In greater detail, a paraxial region of a lens surface is a central portion of the lens surface surrounding and including the optical axis of the lens surface in which light rays incident to the lens surface make a small angle θ to the optical axis, and the approximations sin θ≈θ, tan θ≈θ, and cos θ≈1 are valid.

The imaging plane may be a virtual surface where a focus is formed by the optical imaging system. Alternatively, the imaging plane may be a surface of an image sensor where light is received through the optical imaging system.

An optical imaging system according to an embodiment includes at least nine lenses.

For example, an optical imaging system according to an embodiment includes a first lens, a second lens, a third lens, a fourth lens, a fifth lens, a sixth lens, a seventh lens, an eighth lens, and a ninth sequentially disposed in ascending numerical order along an optical axis of the optical imaging system from an object side of the optical imaging system toward an imaging plane of the optical imaging system. The first through ninth lenses may be spaced apart from each other along the optical axis by predetermined distances.

An optical imaging system according to an embodiment may further include an image sensor for converting an image of an object incident on the image sensor into an electrical signal.

Furthermore, the optical imaging system may further include an infrared filter (hereinafter referred to as a “filter”) for blocking infrared rays. The filter is disposed between the ninth lens and the image sensor.

Furthermore, the optical imaging system may further include an aperture for controlling an amount of light passing through the optical imaging system.

The first to ninth lenses constituting the optical imaging system according to an embodiment may be made of a plastic material.

Furthermore, at least one of the first to ninth lenses has an aspherical surface. For example, the first to ninth lenses may each have at least one aspherical surface.

For example, at least one of an object-side surface and an image-side surface of each of the first to ninth lenses may be an aspherical surface. In this case, the aspherical surfaces of the first to ninth lenses are expressed by the following Equation 1:

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} \qquad ( 1 )$$

In Equation 1, c is a curvature of the lens surface and is equal to a reciprocal of a radius of curvature of the lens surface at an optical axis of the lens surface, K is a conic constant, and Y is a distance from any point on the aspherical surface of the lens to the optical axis. In addition, constants A to H, J, and L to P are aspherical surface coefficients. Z (also known as sag) is a distance in a direction parallel to an optical axis direction between the point on the aspherical surface of the lens at the distance Y from the optical axis of the aspherical surface to a tangential plane perpendicular to the optical axis and intersecting a vertex of the aspherical surface.

An optical imaging system according to an embodiment may satisfy any one or any combination of any two or more of the following Conditional Expressions 1 to 14:

$$0.9 < ( TTL / ( 2 \times IMG HT ) ) \times Fno \leq 0.95 \qquad ( Conditional Expression 1 )$$

$$1.2 < TTL / f < 1.35 \qquad ( Conditional Expression 2 )$$

$$0 < f 1 / f < 1 \qquad ( Conditional Expression 3 )$$

$$- 1 < f 1 / f 2 < 0 \qquad ( Conditional Expression 4 )$$

$$- 1 < f 1 / f 3 < 1 \qquad ( Conditional Expression 5 )$$

$$70 ° < FOV \times ( IMG HT / f ) < 80 ° \qquad ( Conditional Expression 6 )$$

$$0 < BFL / f < 0.2 \qquad ( Conditional Expression 7 )$$

$$25 < v 1 - v 2 < 40 \qquad ( Conditional Expression 8 )$$

$$- 10 < v 3 - v 2 < 10 \qquad ( Conditional Expression 9 )$$

$$15 < v 1 - ( v 5 + v 6 ) / 2 < 40 \qquad ( Conditional Expression 10 )$$

$$0. 67 < TTL / ( 2 \times IMG HT ) < 0.73 \qquad ( Conditional Expression 11 )$$

$$1.25 < Fno < 1.35 \qquad ( Conditional Expression 12 )$$

$$- 2.6 < f 23 / f 1 < - 2. \qquad ( Conditional Expression 13 )$$

$$0.89 < f 23 / f 2 < 1.1 \qquad ( Conditional Expression 14 )$$

In an embodiment, the optical imaging system may satisfy 0.9<(TTL/(2×IMG HT))×Fno≤0.95 (Conditional Expression 1), where TTL is a distance along an optical axis of the optical imaging system from an object-side surface of the first lens to the imaging plane, IMG HT is one half of a diagonal length of the imaging plane, and Fno is an F-number of the optical imaging system. This may enable the optical imaging system to be miniaturized while capturing a bright image.

In an embodiment, the optical imaging system may satisfy 1.20<TTL/f<1.35 (Conditional Expression 2), where f is a total focal length of the optical imaging system. This may enable the optical imaging system to miniaturized while improving an image resolution of the optical imaging system.

In an embodiment, the optical imaging system may satisfy 0<f1/f<1 (Conditional Expression 3), where f1 is a focal length of the first lens. This may enable a refractive power of the first lens to be appropriately adjusted to significantly reduce occurrence of aberrations.

In an embodiment, the optical imaging system may satisfy −1<f1/f2<0 (Conditional Expression 4), where f2 is a focal length of the second lens. This may enable refractive powers of the first and second lenses to be appropriately adjusted to significantly reduce occurrence of aberrations.

In an embodiment, the optical imaging system may satisfy −1<f1/f3<1 (Conditional Expression 5), where f3 is a focal length of the third lens. This may enable refractive powers of the first and third lenses to be appropriately adjusted to significantly reduce occurrence of aberrations.

In an embodiment, the optical imaging system may satisfy 70°<FOV×(IMG HT/f)<80° (Conditional Expression 6), wherein FOV is a field of view of the optical imaging system. This may enable a resolution of the optical imaging system to be improved.

In an embodiment, the optical imaging system may satisfy 0<BFL/f<0.2 (Conditional Expression 7), where BFL is a distance along the optical axis from an image-side surface of the ninth lens to the imaging plane. This may enable the optical imaging system may be miniaturized while improving an image resolution of the optical imaging system.

In an embodiment, the optical imaging system may satisfy 25<v1−v2<40 (Conditional Expression 8), where v1 is an Abbe number of the first lens, and v2 is an Abbe number of the second lens. This may enable chromatic aberration to be improved.

In an embodiment, the optical imaging system may satisfy −10<v3−v2<10 (Conditional Expression 9), where v3 is an Abbe number of the third lens. This may enable chromatic aberration to be improved.

In an embodiment, the optical imaging system may satisfy 15<v1−(v5+v6)/2<40 (Conditional Expression 10), where v5 is an Abbe number of the fifth lens, and v6 is an Abbe number of the sixth lens. This may enable chromatic aberration to be improved.

In an embodiment, the optical imaging system may satisfy 0.67<TTL/(2×IMG HT)<0.73 (Conditional Expression 11). This may enable the optical imaging system may be miniaturized while improving an image resolution of the optical imaging system.

In an embodiment, the optical imaging system may satisfy 1.25<Fno<1.35 (Conditional Expression 12). This may enable an image brightness and a resolution of the optical imaging system to be improved.

In an embodiment, the optical imaging system may satisfy −2.6<f23/f1<−2.00 (Conditional Expression 13), where f23 is a combined focal length of the second and third lenses. This may enable refractive powers of the first to third lenses be appropriately adjusted to significantly reduce occurrence of aberrations.

In an embodiment, the optical imaging system may satisfy 0.89<f23/f2<1.10 (Conditional Expression 14). This may enable refractive powers of the second and third lenses to be appropriately adjusted to significantly reduce occurrence of aberrations.

In an embodiment, among the nine lenses, two adjacent lenses may have an Abbe number less than 21. Furthermore, the two adjacent lenses may have a refractive index of 1.66 or more. For example, the second lens and the third lens may each have an Abbe number less than 21. Furthermore, the second and third lenses may each have a refractive index of 1.66 or more. A combined focal length of the two adjacent lenses having Abbe numbers less than 21 may have a negative value.

In an embodiment, both of the two adjacent lenses having Abbe numbers less than 21 may each have a negative refractive power. In another embodiment, one of the two adjacent lenses having Abbe numbers less than 21 may have a negative refractive power, and another one of the two adjacent lenses having Abbe numbers less than 21 may have a positive refractive power.

In an embodiment, among the two adjacent lenses having Abbe numbers less than 21, a lens closer to an object side of the optical imaging system may have a negative refractive power, and a lens closer to an image side of the optical imaging system may have a positive refractive power or a negative refractive power. In this case, the lens closer to the image side may have a significantly larger focal length. For example, among the two adjacent lenses having Abbe numbers less than 21, an absolute focal length of the lens closer to the image side may be 10 times or more an absolute focal length of the lens closer to the object side.

In an embodiment, at least three of the nine lenses may have a refractive index greater than 1.61. For example, the second lens, the third lens, and the fifth lens may each have a refractive index greater than 1.61.

In an embodiment, among the nine lenses, the ninth lens may have a smallest absolute focal length.

In an embodiment, a combined focal length of the sixth and seventh lenses may have a negative value.

The optical imaging system may be configured to have a field of view greater than 80°. In an embodiment, the field of view of the optical imaging system may be less than 85°.

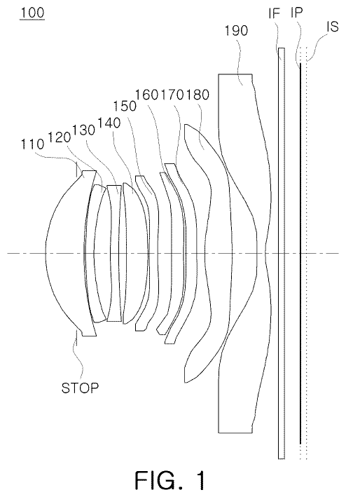

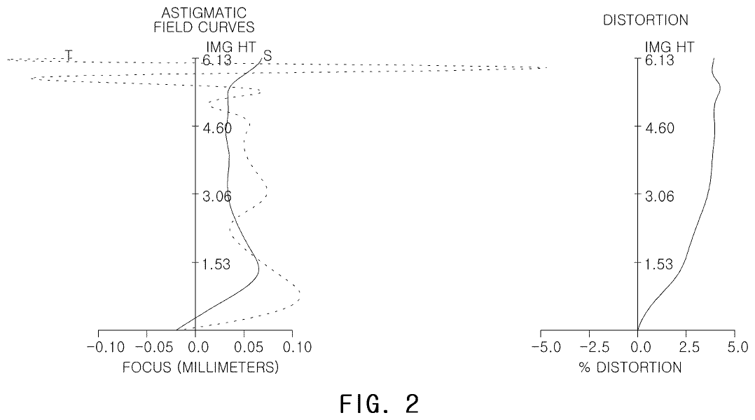

FIG. 1 is a diagram of a configuration of an optical imaging system according to a first embodiment, and FIG. 2 is graphs illustrating aberration characteristics of the optical imaging system illustrated in FIG. 1.

Referring to FIG. 1, an optical imaging system 100 according to the first embodiment includes a first lens 110, a second lens 120, a third lens 130, a fourth lens 140, a fifth lens 150, a sixth lens 160, a seventh lens 170, an eighth lens 180, and a ninth lens 190 sequentially disposed in ascending numerical order along an optical axis of the optical imaging system 100 from an object side of the optical imaging system 100 toward an imaging plane IP of the optical imaging system 100, and may further include a filter IF and an image sensor IS disposed after an image-side surface of the ninth lens 190. The imaging plane IP may be formed on a surface of the image sensor IS.

An aperture STOP may be disposed in front of an object-side surface of the first lens 110.

The optical imaging system 100 according to the first embodiment may form a focus on the imaging plane IP.

Radiuses of curvature, a thickness of an element, a distance between elements, a refractive index, and an Abbe number of each element of the optical imaging system 100 are illustrated in Table 1 below.

TABLE 1

| Sur- | | | | Refrac- | |
|---|---|---|---|---|---|
| face | | Radius of | Thickness/ | tive | Abbe |
| No. | Element | Curvature | Distance | Index | Number |
| S1 | First | 3.222 | 1.305 | 1.544 | 56.0 |
| S2 | Lens | 31.033 | 0.057 | | |
| S3 | Second | 10.432 | 0.280 | 1.671 | 19.4 |
| S4 | Lens | 5.306 | 0.561 | | |
| S5 | Third | 9.928 | 0.280 | 1.660 | 20.4 |
| S6 | Lens | 9.027 | 0.271 | | |
| S7 | Fourth | −31.142 | 0.727 | 1.544 | 56.0 |
| S8 | Lens | −8.996 | 0.050 | | |
| S9 | Fifth | 12.269 | 0.280 | 1.651 | 21.5 |
| S10 | Lens | 8.571 | 0.474 | | |
| S11 | Sixth | 30.323 | 0.413 | 1.567 | 37.4 |
| S12 | Lens | 18.117 | 0.070 | | |
| S13 | Seventh | 18.366 | 0.380 | 1.567 | 37.4 |
| S14 | Lens | 19.490 | 0.275 | | |
| S15 | Eighth | 4.577 | 0.931 | 1.544 | 56.0 |
| S16 | Lens | −9.207 | 0.845 | | |
| S17 | Ninth | 22.521 | 0.280 | 1.535 | 55.7 |
| S18 | Lens | 2.070 | 0.448 | | |
| S19 | Filter | Infinity | 0.210 | 1.517 | 64.2 |
| S20 | | Infinity | 0.537 | | |
| S21 | Imaging | Infinity | | | |
| | Plane | | | | |

In the first embodiment, the first lens 110 has a positive refractive power, an object-side surface of the first lens 110 is convex in a paraxial region thereof, and an image-side surface of the first lens 110 is concave in a paraxial region thereof.

The second lens 120 has a negative refractive power, an object-side surface of the second lens 120 is convex in a paraxial region thereof, and an image-side surface of the second lens 120 is concave in a paraxial region thereof.

The third lens 130 has a negative refractive power, an object-side surface of the third lens 130 is convex in the paraxial region thereof, and an image-side surface of the third lens 130 is concave in the paraxial region thereof.

The fourth lens 140 has a positive refractive power, an object-side surface of the fourth lens 140 is concave in the paraxial region thereof, and an image-side surface of the fourth lens 140 is convex in the paraxial region thereof.

The fifth lens 150 has a negative refractive power, an object-side surface of the fifth lens 150 is convex in the paraxial region thereof, and an image-side surface of the fifth lens 150 is concave in the paraxial region thereof.

The sixth lens 160 has a negative refractive power, an object-side surface of the sixth lens 160 is convex in the paraxial region thereof, and an image-side surface of the sixth lens 160 is concave in the paraxial region thereof.

The seventh lens 170 has a positive refractive power, an object-side surface of the seventh lens 170 is convex in the paraxial region thereof, and an image-side surface of the seventh lens 170 is concave in the paraxial region thereof.

The eighth lens 180 has a positive refractive power, and an object-side surface and an image-side surface of the eighth lens 180 are convex in respective paraxial regions thereof.

The ninth lens 190 has a negative refractive power, an object-side surface of the ninth lens 190 is convex in a paraxial region thereof, and an image-side surface of the ninth lens 190 is concave in a paraxial region thereof.

At least one of the third lens 130, fifth lens 150, eighth lens 180, and ninth lens 190 has at least one inflection point on at least one of the object-side surface and the image-side surface thereof.

The surfaces of the first lens 110 to the ninth lens 190 have aspheric coefficients as illustrated in Table 2 below. For example, all of the object-side surfaces and the image-side surfaces of the first lens 110 to the ninth lens 190 are aspherical surfaces.

TABLE 2

| | S1 | S2 | S3 | S4 | S5 | S6 |
|---|---|---|---|---|---|---|
| K | −5.030E−01 | 3.388E+01 | 8.155E+00 | −7.944E+00 | −5.624E+01 | 1.100E+01 |
| A | 7.389E−03 | 3.185E−03 | −7.586E−04 | −9.897E−03 | 3.060E−03 | −4.130E−03 |
| B | −2.284E−02 | 2.887E−03 | −1.978E−02 | 3.782E−02 | −6.025E−02 | −2.321E−02 |
| C | 5.344E−02 | −1.188E−02 | 5.065E−02 | −9.419E−02 | 1.670E−01 | 3.731E−02 |
| D | −7.461E−02 | 2.122E−02 | −7.643E−02 | 1.474E−01 | −3.124E−01 | −4.119E−02 |
| E | 6.882E−02 | −2.265E−02 | 7.802E−02 | −1.498E−01 | 3.912E−01 | 2.994E−02 |
| F | −4.415E−02 | 1.586E−02 | −5.652E−02 | 1.019E−01 | −3.408E−01 | −1.646E−02 |
| G | 2.029E−02 | −7.658E−03 | 2.978E−02 | −4.650E−02 | 2.125E−01 | 9.031E−03 |
| H | −6.777E−03 | 2.626E−03 | −1.152E−02 | 1.359E−02 | −9.624E−02 | −5.269E−03 |
| J | 1.647E−03 | −6.469E−04 | 3.272E−03 | −2.081E−03 | 3.177E−02 | 2.561E−03 |
| L | −2.881E−04 | 1.141E−04 | −6.725E−04 | −6.584E−05 | −7.572E−03 | −8.768E−04 |
| M | 3.530E−05 | −1.410E−05 | 9.733E−05 | 1.039E−04 | 1.270E−03 | 1.982E−04 |
| N | −2.874E−06 | 1.162E−06 | −9.397E−06 | −2.196E−05 | −1.422E−04 | −2.812E−05 |
| O | 1.395E−07 | −5.744E−08 | 5.431E−07 | 2.166E−06 | 9.553E−06 | 2.267E−06 |
| P | −3.055E−09 | 1.289E−09 | −1.421E−08 | −8.716E−08 | −2.910E−07 | −7.924E−08 |
| | S7 | S8 | S9 | S10 | S11 | S12 |
| K | −2.356E+02 | 1.318E+01 | −3.720E+01 | −1.924E+01 | −6.481E+00 | 3.622E+01 |
| A | −2.373E−02 | 1.050E−02 | −2.816E−02 | −2.279E−02 | −9.186E−03 | −4.361E−03 |
| B | 1.372E−01 | −1.124E−01 | −3.018E−02 | −6.215E−03 | −6.815E−04 | −1.235E−01 |
| C | −4.037E−01 | 3.295E−01 | 8.370E−02 | 1.023E−02 | −2.412E−02 | 2.628E−01 |
| D | 7.452E−01 | −5.455E−01 | −7.977E−02 | 9.632E−03 | 5.253E−02 | −3.316E−01 |
| E | −9.324E−01 | 5.896E−01 | 1.485E−02 | −3.205E−02 | −5.994E−02 | 2.724E−01 |
| F | 8.223E−01 | −4.451E−01 | 4.067E−02 | 3.468E−02 | 4.499E−02 | −1.525E−01 |
| G | −5.237E−01 | 2.422E−01 | −4.848E−02 | −2.225E−02 | −2.364E−02 | 5.998E−02 |
| H | 2.438E−01 | −9.630E−02 | 2.894E−02 | 9.545E−03 | 8.876E−03 | −1.687E−02 |
| J | −8.301E−02 | 2.800E−02 | −1.098E−02 | −2.847E−03 | −2.394E−03 | 3.410E−03 |
| L | 2.045E−02 | −5.891E−03 | 2.792E−03 | 5.943E−04 | 4.600E−04 | −4.910E−04 |
| M | −3.548E−03 | 8.724E−04 | −4.766E−04 | −8.531E−05 | −6.144E−05 | 4.910E−05 |
| N | 4.111E−04 | −8.626E−05 | 5.247E−05 | 8.035E−06 | 5.418E−06 | −3.240E−06 |
| O | −2.855E−05 | 5.112E−06 | −3.371E−06 | −4.476E−07 | −2.833E−07 | 1.267E−07 |
| P | 8.988E−07 | −1.373E−07 | 9.604E−08 | 1.119E−08 | 6.649E−09 | −2.224E−09 |

| | S13 | S14 | S15 | S16 | S17 | S18 |
|---|---|---|---|---|---|---|
| K | 3.719E+01 | 3.846E+01 | −1.176E+01 | −9.897E+01 | 1.266E+01 | −7.910E+00 |
| A | −1.755E−02 | −3.268E−02 | 7.532E−03 | 1.807E−02 | −1.327E−01 | −6.624E−02 |
| B | −1.173E−01 | −3.639E−02 | −1.719E−02 | −1.351E−02 | 4.887E−02 | 2.652E−02 |
| C | 2.750E−01 | 7.626E−02 | 1.038E−02 | 5.067E−03 | −1.319E−02 | −7.327E−03 |
| D | −3.447E−01 | −7.632E−02 | −3.610E−03 | −1.144E−03 | 3.014E−03 | 1.519E−03 |
| E | 2.755E−01 | 4.992E−02 | 7.440E−04 | 2.390E−04 | −5.612E−04 | −2.373E−04 |
| F | −1.497E−01 | −2.293E−02 | −8.103E−05 | −6.466E−05 | 8.119E−05 | 2.745E−05 |
| G | 5.712E−02 | 7.555E−03 | −5.784E−07 | 1.554E−05 | −8.923E−06 | −2.325E−06 |
| H | −1.556E−02 | −1.797E−03 | 1.662E−06 | −2.602E−06 | 7.371E−07 | 1.434E−07 |
| J | 3.037E−03 | 3.078E−04 | −2.705E−07 | 2.947E−07 | −4.530E−08 | −6.393E−09 |
| L | −4.213E−04 | −3.749E−05 | 2.345E−08 | −2.268E−08 | 2.037E−09 | 2.032E−10 |
| M | 4.050E−05 | 3.163E−06 | −1.234E−09 | 1.173E−09 | −6.494E−11 | −4.481E−12 |
| N | −2.564E−06 | −1.755E−07 | 3.924E−11 | −3.904E−11 | 1.389E−12 | 6.504E−14 |
| O | 9.604E−08 | 5.755E−09 | −6.903E−13 | 7.572E−13 | −1.786E−14 | −5.585E−16 |
| P | −1.613E−09 | −8.448E−11 | 5.100E−15 | −6.501E−15 | 1.042E−16 | 2.148E−18 |

The optical imaging system 100 configured as described above may have the aberration characteristics illustrated in FIG. 2.

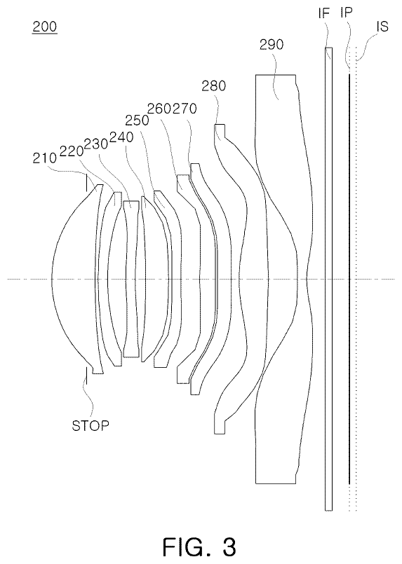

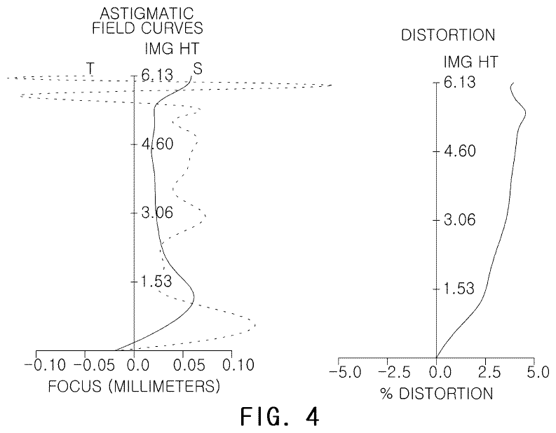

FIG. 3 is a diagram of a configuration of an optical imaging system according to a second embodiment, and FIG. 4 is graphs illustrating aberration characteristics of the optical imaging system illustrated in FIG. 3.

Referring to FIG. 3, an optical imaging system 200 according to the second embodiment includes a first lens 210, a second lens 220, a third lens 230, a fourth lens 240, a fifth lens 250, a sixth lens 260, a seventh lens 270, an eighth lens 280, and a ninth lens 290 sequentially disposed in ascending numerical order along an optical axis of the optical imaging system 200 from an object side of the optical imaging system 200 toward an imaging plane IP of the optical imaging system 200, and may further include a filter IF and an image sensor IS disposed after an image-side surface of the ninth lens 290. The imaging plane IP may be formed on a surface of the image sensor IS.

An aperture STOP may be disposed in front of an object-side surface of the first lens 210.

The optical imaging system 200 according to the second embodiment may form a focus on the imaging plane IP.

Radiuses of curvature, a thickness of an element, a distance between elements, a refractive index, and an Abbe number of each element of the optical imaging system 200 are illustrated in Table 3 below.

TABLE 3

| Sur- | | | | Refrac- | |
|---|---|---|---|---|---|
| face | | Radius of | Thickness/ | tive | Abbe |
| No. | Element | Curvature | Distance | Index | Number |
| S1 | First | 3.206 | 1.313 | 1.544 | 56.0 |
| S2 | Lens | 30.041 | 0.050 | | |
| S3 | Second | 10.046 | 0.280 | 1.671 | 19.4 |
| S4 | Lens | 5.139 | 0.557 | | |
| S5 | Third | 9.594 | 0.280 | 1.671 | 19.4 |
| S6 | Lens | 8.883 | 0.285 | | |
| S7 | Fourth | −30.687 | 0.696 | 1.544 | 56.0 |
| S8 | Lens | −9.071 | 0.068 | | |
| S9 | Fifth | 21.548 | 0.280 | 1.651 | 21.5 |
| S10 | Lens | 12.414 | 0.522 | | |
| S11 | Sixth | 29.851 | 0.420 | 1.567 | 37.4 |
| S12 | Lens | 18.286 | 0.070 | | |
| S13 | Seventh | 18.617 | 0.411 | 1.544 | 56.0 |
| S14 | Lens | 19.690 | 0.209 | | |
| S15 | Eighth | 4.474 | 0.884 | 1.544 | 56.0 |
| S16 | Lens | −10.171 | 0.885 | | |
| S17 | Ninth | 23.744 | 0.280 | 1.535 | 55.7 |
| S18 | Lens | 2.095 | 0.448 | | |
| S19 | Filter | Infinity | 0.210 | 1.517 | 64.2 |
| S20 | | Infinity | 0.524 | | |
| S21 | Imaging | Infinity | | | |
| | Plane | | | | |

In the second embodiment, the first lens 210 has a positive refractive power, an object-side surface of the first lens 210 is convex in a paraxial region thereof, and an image-side surface of the first lens 210 is concave in a paraxial region thereof.

The second lens 220 has a negative refractive power, an object-side surface of the second lens 220 is convex in a paraxial region thereof, and an image-side surface of the second lens 220 is concave in a paraxial region thereof.

The third lens 230 has a negative refractive power, an object-side surface of the third lens 230 is convex in a paraxial region thereof, and an image-side surface of the third lens 230 is concave in a paraxial region thereof.

The fourth lens 240 has a positive refractive power, an object-side surface of the fourth lens 240 is concave in a paraxial region thereof, and an image-side surface of the fourth lens 240 is convex in a paraxial region thereof.

The fifth lens 250 has a negative refractive power, an object-side surface of the fifth lens 250 is convex in a paraxial region thereof, and an image-side surface of the fifth lens 250 is concave in a paraxial region thereof.

The sixth lens 260 has a negative refractive power, an object-side surface of the sixth lens 260 is convex in a paraxial region thereof, and an image-side surface of the sixth lens 260 is concave in a paraxial region thereof.

The seventh lens 270 has a positive refractive power, an object-side surface of the seventh lens 270 is convex in a paraxial region thereof, and an image-side surface of the seventh lens 270 is concave in a paraxial region thereof.

The eighth lens 280 has a positive refractive power, and an object-side surface and an image-side surface of the eighth lens 280 are convex in respective paraxial regions thereof.

The ninth lens 290 has a negative refractive power, an object-side surface of the ninth lens 290 is convex in a paraxial region thereof, and an image-side surface of the ninth lens 290 is concave in a paraxial region thereof.

At least one of the third lens 230, the fifth lens 250, the eighth lens 280, and the ninth lens 290 has at least one inflection point on at least one of the object-side surface and the image-side surface thereof.

The surfaces of the first lens 210 to the ninth lens 290 have aspheric coefficients as illustrated in Table 4 below. For example, all of the object-side surfaces and the image-side surfaces of the first lens 210 to the ninth lens 290 are aspherical surfaces.

TABLE 4

| | S1 | S2 | S3 | S4 | S5 | S6 |
|---|---|---|---|---|---|---|
| K | −4.968E−01 | 3.520E+01 | 8.022E+00 | −7.381E+00 | −5.043E+01 | 1.114E+01 |
| A | 8.178E−03 | 8.325E−03 | 4.947E−03 | −4.114E−03 | −2.455E−03 | −9.741E−03 |
| B | −2.467E−02 | −1.772E−02 | −4.453E−02 | 1.192E−02 | −3.049E−02 | 3.148E−03 |
| C | 5.608E−02 | 2.944E−02 | 1.041E−01 | −2.729E−02 | 8.030E−02 | −4.379E−02 |
| D | −7.705E−02 | −3.051E−02 | −1.497E−01 | 3.536E−02 | −1.525E−01 | 1.242E−01 |
| E | 7.025E−02 | 2.137E−02 | 1.472E−01 | −1.948E−02 | 1.926E−01 | −2.030E−01 |
| F | −4.463E−02 | −1.071E−02 | −1.035E−01 | −7.035E−03 | −1.676E−01 | 2.164E−01 |
| G | 2.033E−02 | 3.968E−03 | 5.314E−02 | 2.010E−02 | 1.037E−01 | −1.590E−01 |
| H | −6.732E−03 | −1.101E−03 | −2.007E−02 | −1.634E−02 | −4.637E−02 | 8.289E−02 |
| J | 1.622E−03 | 2.271E−04 | 5.567E−03 | 7.769E−03 | 1.507E−02 | −3.103E−02 |
| L | −2.815E−04 | −3.409E−05 | −1.119E−03 | −2.408E−03 | −3.528E−03 | 8.301E−03 |
| M | 3.422E−05 | 3.567E−06 | 1.583E−04 | 4.946E−04 | 5.809E−04 | −1.552E−03 |
| N | −2.764E−06 | −2.423E−07 | −1.494E−05 | −6.525E−05 | −6.387E−05 | 1.929E−04 |
| O | 1.332E−07 | 9.353E−09 | 8.443E−07 | 5.023E−06 | 4.214E−06 | −1.432E−05 |
| P | −2.894E−09 | −1.484E−10 | −2.160E−08 | −1.720E−07 | −1.262E−07 | 4.809E−07 |

| | S7 | S8 | S9 | S10 | S11 | S12 |
|---|---|---|---|---|---|---|
| K | −7.895E+01 | 1.318E+01 | −3.769E+01 | −2.332E+01 | 4.797E+01 | 3.535E+01 |
| A | −6.266E−03 | 4.217E−02 | 1.610E−02 | −1.031E−03 | −8.811E−03 | −1.805E−02 |
| B | 5.259E−02 | −1.911E−01 | −1.427E−01 | −4.816E−02 | 4.846E−02 | −1.002E−02 |
| C | −1.737E−01 | 4.255E−01 | 2.489E−01 | 5.113E−02 | −1.473E−01 | 3.036E−03 |
| D | 3.484E−01 | −6.080E−01 | −2.697E−01 | −1.789E−02 | 2.155E−01 | −1.466E−02 |
| E | −4.698E−01 | 5.990E−01 | 1.984E−01 | −1.815E−02 | −1.994E−01 | 2.776E−02 |
| F | 4.443E−01 | −4.213E−01 | −1.021E−01 | 2.976E−02 | 1.271E−01 | −2.404E−02 |
| G | −3.024E−01 | 2.149E−01 | 3.670E−02 | −2.140E−02 | −5.786E−02 | 1.239E−02 |
| H | 1.501E−01 | −7.996E−02 | −9.031E−03 | 9.725E−03 | 1.911E−02 | −4.192E−03 |
| J | −5.434E−02 | 2.161E−02 | 1.462E−03 | −3.018E−03 | −4.593E−03 | 9.675E−04 |
| L | 1.420E−02 | −4.180E−03 | −1.471E−04 | 6.508E−04 | 7.955E−04 | −1.536E−04 |
| M | −2.608E−03 | 5.608E−04 | 9.550E−06 | −9.623E−05 | −9.674E−05 | 1.651E−05 |
| N | 3.188E−04 | −4.927E−05 | −8.152E−07 | 9.330E−06 | 7.837E−06 | −1.149E−06 |
| O | −2.330E−05 | 2.527E−06 | 1.019E−07 | −5.353E−07 | −3.796E−07 | 4.668E−08 |
| P | 7.691E−07 | −5.665E−08 | −5.753E−09 | 1.380E−08 | 8.314E−09 | −8.411E−10 |

| | S13 | S14 | S15 | S16 | S17 | S18 |
|---|---|---|---|---|---|---|
| K | 3.696E+01 | 3.822E+01 | −1.130E+01 | −9.897E+01 | 1.667E+01 | −8.642E+00 |
| A | −3.711E−02 | −9.983E−03 | 2.842E−02 | 2.728E−02 | −1.360E−01 | −6.437E−02 |
| B | −6.066E−03 | −6.947E−02 | −4.414E−02 | −1.815E−02 | 5.232E−02 | 2.489E−02 |
| C | 2.245E−02 | 9.186E−02 | 3.031E−02 | 6.156E−03 | −1.547E−02 | −6.597E−03 |
| D | −3.988E−02 | −7.098E−02 | −1.347E−02 | −1.298E−03 | 3.883E−03 | 1.318E−03 |
| E | 4.623E−02 | 3.899E−02 | 4.177E−03 | 2.591E−04 | −7.646E−04 | −1.993E−04 |
| F | −3.340E−02 | −1.605E−02 | −9.470E−04 | −6.943E−05 | 1.125E−04 | 2.236E−05 |
| G | 1.569E−02 | 4.961E−03 | 1.599E−04 | 1.682E−05 | −1.224E−05 | −1.840E−06 |
| H | −4.986E−03 | −1.136E−03 | −2.024E−05 | −2.843E−06 | 9.818E−07 | 1.102E−07 |
| J | 1.093E−03 | 1.900E−04 | 1.912E−06 | 3.252E−07 | −5.788E−08 | −4.770E−09 |
| L | −1.658E−04 | −2.274E−05 | −1.327E−07 | −2.528E−08 | 2.475E−09 | 1.472E−10 |
| M | 1.709E−05 | 1.890E−06 | 6.548E−09 | 1.320E−09 | −7.467E−11 | −3.153E−12 |
| N | −1.142E−06 | −1.033E−07 | −2.166E−10 | −4.437E−11 | 1.506E−12 | 4.445E−14 |
| O | 4.468E−08 | 3.340E−09 | 4.287E−12 | 8.691E−13 | −1.822E−14 | −3.706E−16 |
| P | −7.761E−10 | −4.829E−11 | −3.828E−14 | −7.536E−15 | 9.998E−17 | 1.385E−18 |

The optical imaging system 200 configured as described above may have the aberration characteristics illustrated in FIG. 4.

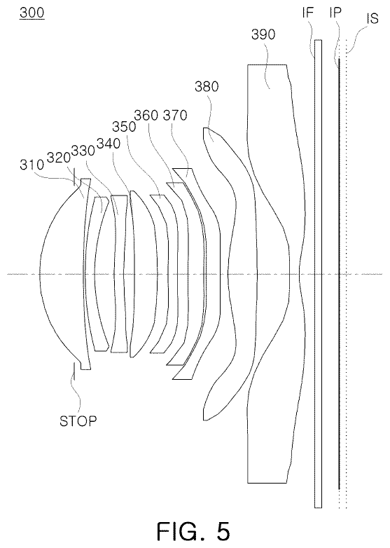

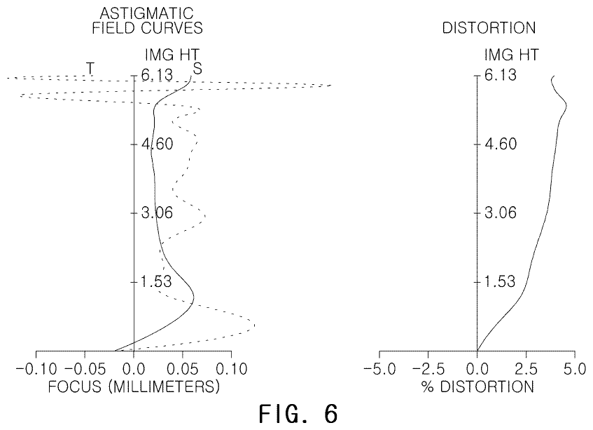

FIG. 5 is a diagram of a configuration of an optical imaging system according to a third embodiment, and FIG. 6 is graphs illustrating aberration characteristics of the optical imaging system illustrated in FIG. 5.

Referring to FIG. 5, an optical imaging system 300 according to the third embodiment includes a first lens 310, a second lens 320, a third lens 330, a fourth lens 340, a fifth lens 350, a sixth lens 360, a seventh lens 370, an eighth lens 380, and a ninth lens 390 sequentially disposed in ascending numerical order along an optical axis of the optical imaging system 300 from an object side of the optical imaging system 300 toward an imaging plane IP of the optical imaging system 300, and may further include a filter IF and an image sensor IS disposed after an image-side surface of the ninth lens 390. The imaging plane IP may be formed on a surface of the image sensor IS.

An aperture STOP may be disposed in front of an object-side surface of the first lens 310.

The optical imaging system 300 according to the third embodiment may form a focus on the imaging plane IP.

Radiuses of curvature, a thickness of an element, a distance between elements, a refractive index, and an Abbe number of each element of the optical imaging system 300 are illustrated in Table 5 below.

TABLE 5

| Sur- | | | | Refrac- | |
|---|---|---|---|---|---|
| face | | Radius of | Thickness/ | tive | Abbe |
| No. | Element | Curvature | Distance | Index | Number |
| S1 | First | 3.206 | 1.313 | 1.544 | 56.0 |
| S2 | Lens | 30.100 | 0.050 | | |
| S3 | Second | 10.051 | 0.280 | 1.671 | 19.4 |
| S4 | Lens | 5.138 | 0.558 | | |
| S5 | Third | 9.589 | 0.280 | 1.671 | 19.4 |
| S6 | Lens | 8.881 | 0.285 | | |
| S7 | Fourth | −30.706 | 0.696 | 1.544 | 56.0 |
| S8 | Lens | −9.075 | 0.068 | | |
| S9 | Fifth | 21.888 | 0.280 | 1.651 | 21.5 |
| S10 | Lens | 12.499 | 0.522 | | |
| S11 | Sixth | 29.648 | 0.417 | 1.567 | 37.4 |
| S12 | Lens | 18.270 | 0.070 | | |
| S13 | Seventh | 18.601 | 0.410 | 1.544 | 56.0 |
| S14 | Lens | 19.690 | 0.209 | | |
| S15 | Eighth | 4.446 | 0.884 | 1.544 | 56.0 |
| S16 | Lens | −10.506 | 0.889 | | |
| S17 | Ninth | 23.802 | 0.280 | 1.535 | 55.7 |
| S18 | Lens | 2.104 | 0.448 | | |
| S19 | Filter | Infinity | 0.210 | 1.517 | 64.2 |
| S20 | | Infinity | 0.522 | | |
| S21 | Imaging | Infinity | | | |
| | Plane | | | | |

In the third embodiment, the first lens 310 has a positive refractive power, an object-side surface of the first lens 310 is convex in a paraxial region thereof, and an image-side surface of the first lens 310 is concave in a paraxial region thereof.

The second lens 320 has a negative refractive power, an object-side surface of the second lens 320 is convex in a paraxial region thereof, and an image-side surface of the second lens 320 is concave in a paraxial region thereof.

The third lens 330 has a negative refractive power, an object-side surface of the third lens 330 is convex in a paraxial region thereof, and an image-side surface of the third lens 330 is concave in a paraxial region thereof.

The fourth lens 340 has a positive refractive power, an object-side surface of the fourth lens 340 is concave in a paraxial region thereof, and an image-side surface of the fourth lens 340 is convex in a paraxial region thereof.

The fifth lens 350 has a negative refractive power, an object-side surface of the fifth lens 350 is convex in a paraxial region thereof, and an image-side surface of the fifth lens 350 is concave in a paraxial region thereof.

The sixth lens 360 has a negative refractive power, an object-side surface of the sixth lens 360 is convex in a paraxial region thereof, and an image-side surface of the sixth lens 360 is concave in a paraxial region thereof.

The seventh lens 370 has a positive refractive power, an object-side surface of the seventh lens 370 is convex in a paraxial region thereof, and an image-side surface of the seventh lens 370 is concave in a paraxial region thereof.

The eighth lens 380 has a positive refractive power, and an object-side surface and an image-side surface of the eighth lens 380 are convex in respective paraxial regions thereof.

The ninth lens 390 has a negative refractive power, an object-side surface of the ninth lens 390 is convex in a paraxial region thereof, and an image-side surface of the ninth lens 390 is concave in a paraxial region thereof.

At least one of the third lens 330, the fifth lens 350, the eighth lens 380, and the ninth lens 390 has at least one inflection point on at least one of the object-side surface and the image-side surface thereof.

The surfaces of the first lens 310 to the ninth lens 390 have aspheric coefficients as illustrated in Table 6 below. For example, all of the object-side surfaces and the image-side surfaces of the first lens 310 to the ninth lens 390 are aspherical surfaces.

TABLE 6

| | S1 | S2 | S3 | S4 | S5 | Se |
|---|---|---|---|---|---|---|
| K | −4.966E−01 | 3.525E+01 | 8.012E+00 | −7.380E+00 | −5.031E+01 | 1.115E+01 |
| A | 8.300E−03 | 7.663E−03 | 4.239E−03 | −4.365E−03 | −2.401E−03 | −9.730E−03 |
| B | −2.499E−02 | −1.408E−02 | −4.004E−02 | 1.459E−02 | −3.113E−02 | 3.581E−03 |
| C | 5.645E−02 | 2.060E−02 | 9.168E−02 | −3.786E−02 | 8.278E−02 | −4.743E−02 |
| D | −7.721E−02 | −1.791E−02 | −1.293E−01 | 5.891E−02 | −1.579E−01 | 1.364E−01 |
| E | 7.017E−02 | 9.618E−03 | 1.255E−01 | −5.328E−02 | 2.003E−01 | −2.259E−01 |
| F | −4.448E−02 | −3.125E−03 | −8.742E−02 | 2.623E−02 | −1.752E−01 | 2.440E−01 |
| G | 2.023E−02 | 4.749E−04 | 4.459E−02 | −3.109E−03 | 1.089E−01 | −1.817E−01 |
| H | −6.689E−03 | 6.523E−05 | −1.678E−02 | −4.675E−03 | −4.895E−02 | 9.603E−02 |
| J | 1.611E−03 | −5.542E−05 | 4.646E−03 | 3.538E−03 | 1.598E−02 | −3.641E−02 |
| L | −2.793E−04 | 1.514E−05 | −9.332E−04 | −1.310E−03 | −3.754E−03 | 9.864E−03 |
| M | 3.394E−05 | −2.440E−06 | 1.321E−04 | 2.960E−04 | 6.196E−04 | −1.866E−03 |
| N | −2.742E−06 | 2.448E−07 | −1.249E−05 | −4.150E−05 | −6.820E−05 | 2.343E−04 |
| O | 1.321E−07 | −1.421E−08 | 7.070E−07 | 3.335E−06 | 4.498E−06 | −1.756E−05 |
| P | −2.870E−09 | 3.664E−10 | −1.812E−08 | −1.180E−07 | −1.345E−07 | 5.940E−07 |

| | S7 | S8 | S9 | S10 | S11 | S12 |
|---|---|---|---|---|---|---|
| K | −7.819E+01 | 1.317E+01 | −3.799E+01 | −2.338E+01 | 4.945E+01 | 3.520E+01 |
| A | −6.405E−03 | 4.198E−02 | 1.678E−02 | −1.914E−04 | −9.112E−03 | −2.274E−02 |
| B | 5.347E−02 | −1.876E−01 | −1.432E−01 | −5.123E−02 | 5.125E−02 | 1.326E−02 |
| C | −1.769E−01 | 4.119E−01 | 2.466E−01 | 5.904E−02 | −1.533E−01 | −4.390E−02 |
| D | 3.552E−01 | −5.810E−01 | −2.640E−01 | −3.237E−02 | 2.221E−01 | 3.809E−02 |
| E | −4.792E−01 | 5.654E−01 | 1.918E−01 | −3.277E−04 | −2.035E−01 | −9.876E−03 |
| F | 4.532E−01 | −3.929E−01 | −9.710E−02 | 1.481E−02 | 1.284E−01 | −5.808E−03 |
| G | −3.085E−01 | 1.979E−01 | 3.405E−02 | −1.263E−02 | −5.783E−02 | 6.166E−03 |
| H | 1.531E−01 | −7.252E−02 | −8.004E−03 | 6.076E−03 | 1.890E−02 | −2.666E−03 |
| J | −5.545E−02 | 1.925E−02 | 1.165E−03 | −1.932E−03 | −4.499E−03 | 6.973E−04 |
| L | 1.449E−02 | −3.640E−03 | −8.276E−05 | 4.210E−04 | 7.723E−04 | −1.193E−04 |
| M | −2.661E−03 | 4.742E−04 | −5.593E−07 | −6.254E−05 | −9.314E−05 | 1.347E−05 |
| N | 3.255E−04 | −4.003E−05 | 2.763E−07 | 6.074E−06 | 7.489E−06 | −9.696E−07 |
| O | −2.379E−05 | 1.938E−06 | 2.989E−08 | −3.487E−07 | −3.603E−07 | 4.038E−08 |
| P | 7.855E−07 | −3.968E−08 | −3.575E−09 | 8.993E−09 | 7.841E−09 | −7.408E−10 |

| | S13 | S14 | S15 | S16 | S17 | S18 |
|---|---|---|---|---|---|---|
| K | 3.690E+01 | 3.822E+01 | −1.132E+01 | −9.897E+01 | 1.679E+01 | −8.678E+00 |
| A | −4.235E−02 | −1.042E−02 | 2.879E−02 | 2.773E−02 | −1.362E−01 | −6.450E−02 |
| B | 1.994E−02 | −6.572E−02 | −4.447E−02 | −1.837E−02 | 5.252E−02 | 2.491E−02 |
| C | −2.935E−02 | 8.433E−02 | 3.040E−02 | 6.206E−03 | −1.559E−02 | −6.599E−03 |
| D | 1.723E−02 | −6.335E−02 | −1.346E−02 | −1.304E−03 | 3.927E−03 | 1.319E−03 |
| E | 6.329E−03 | 3.420E−02 | 4.163E−03 | 2.598E−04 | −7.745E−04 | −1.993E−04 |
| F | −1.446E−02 | −1.403E−02 | −9.434E−04 | −6.956E−05 | 1.140E−04 | 2.237E−05 |
| G | 9.346E−03 | 4.356E−03 | 1.595E−04 | 1.685E−05 | −1.239E−05 | −1.840E−06 |
| H | −3.457E−03 | −1.006E−03 | −2.025E−05 | −2.850E−06 | 9.934E−07 | 1.102E−07 |
| J | 8.270E−04 | 1.697E−04 | 1.921E−06 | 3.261E−07 | −5.850E−08 | −4.773E−09 |
| L | −1.326E−04 | −2.046E−05 | −1.339E−07 | −2.535E−08 | 2.498E−09 | 1.473E−10 |
| M | 1.419E−05 | 1.712E−06 | 6.636E−09 | 1.324E−09 | −7.527E−11 | −3.155E−12 |
| N | −9.749E−07 | −9.414E−08 | −2.203E−10 | −4.453E−11 | 1.516E−12 | 4.448E−14 |
| O | 3.891E−08 | 3.056E−09 | 4.375E−12 | 8.724E−13 | −1.832E−14 | −3.709E−16 |
| P | −6.864E−10 | −4.436E−11 | −3.917E−14 | −7.566E−15 | 1.004E−16 | 1.386E−18 |

The optical imaging system 300 configured as described above may have the aberration characteristics illustrated in FIG. 6.

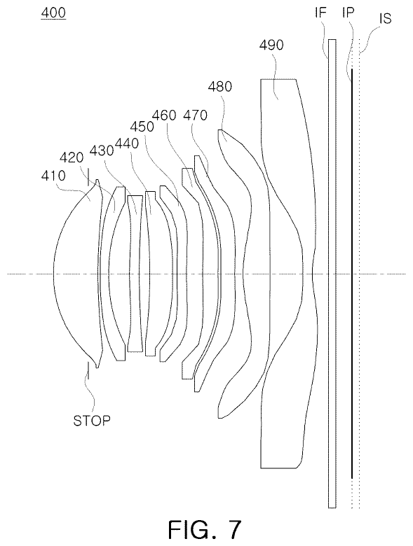

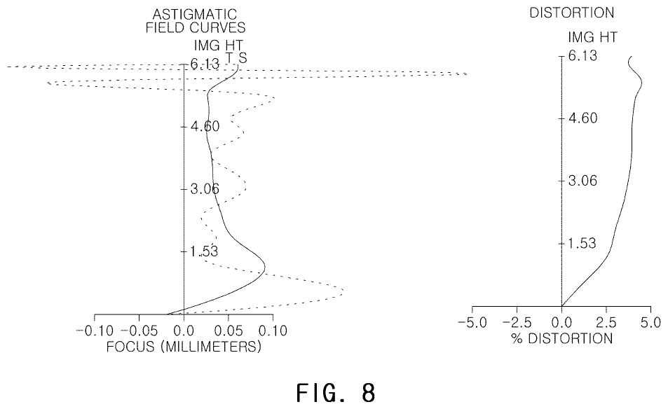

FIG. 7 is a diagram of a configuration of an optical imaging system according to a fourth embodiment, and FIG. 8 is graphs illustrating aberration characteristics of the optical imaging system illustrated in FIG. 7.

Referring to FIG. 7, an optical imaging system 400 according to the fourth embodiment includes a first lens 410, a second lens 420, a third lens 430, a fourth lens 440, a fifth lens 450, a sixth lens 460, a seventh lens 470, an eighth lens 480, and a ninth lens 490 sequentially disposed in ascending numerical order along an optical axis of the optical imaging system 400 from an object side of the optical imaging system 400 toward an imaging plane IP of the optical imaging system 400, and may further include a filter IF and an image sensor IS disposed after an image-side surface of the ninth lens 490. The imaging plane IP may be formed on a surface of the image sensor IS.

An aperture STOP may be disposed in front of an object-side surface of the first lens 410.

The optical imaging system 400 according to the fourth embodiment may form a focus on the imaging plane IP.

Radiuses of curvature, a thickness of an element, a distance between elements, a refractive index, and an Abbe number of each element of the optical imaging system 400 are illustrated in Table 7 below.

TABLE 7

| Sur- | | | | Refrac- | |
|---|---|---|---|---|---|
| face | | Radius of | Thickness/ | tive | Abbe |
| No. | Element | Curvature | Distance | Index | Number |
| S1 | First | 3.197 | 1.339 | 1.544 | 56.0 |
| S2 | Lens | 30.231 | 0.050 | | |
| S3 | Second | 9.992 | 0.280 | 1.687 | 18.3 |
| S4 | Lens | 5.090 | 0.561 | | |
| S5 | Third | 9.541 | 0.280 | 1.671 | 19.4 |
| S6 | Lens | 8.915 | 0.297 | | |
| S7 | Fourth | −29.534 | 0.701 | 1.544 | 56.0 |
| S8 | Lens | −9.019 | 0.092 | | |
| S9 | Fifth | 20.062 | 0.280 | 1.614 | 26.3 |
| S10 | Lens | 11.195 | 0.465 | | |
| S11 | Sixth | 25.880 | 0.421 | 1.567 | 37.4 |
| S12 | Lens | 18.358 | 0.070 | | |
| S13 | Seventh | 18.763 | 0.407 | 1.544 | 56.0 |
| S14 | Lens | 19.844 | 0.224 | | |
| S15 | Eighth | 4.069 | 0.814 | 1.544 | 56.0 |
| S16 | Lens | −18.477 | 0.955 | | |
| S17 | Ninth | 23.828 | 0.280 | 1.535 | 55.7 |
| S18 | Lens | 2.185 | 0.448 | | |
| S19 | Filter | Infinity | 0.210 | 1.517 | 64.2 |
| S20 | | Infinity | 0.500 | | |
| S21 | Imaging | Infinity | | | |
| | Plane | | | | |

In the fourth embodiment, the first lens 410 has a positive refractive power, an object-side surface of the first lens 410 is convex in a paraxial region thereof, and an image-side surface of the first lens 410 is concave in a paraxial region thereof.

The second lens 420 has a negative refractive power, an object-side surface of the second lens 420 is convex in a paraxial region thereof, and an image-side surface of the second lens 420 is concave in a paraxial region thereof.

The third lens 430 has a negative refractive power, an object-side surface of the third lens 430 is convex in a paraxial region thereof, and an image-side surface of the third lens 430 is concave in a paraxial region thereof.

The fourth lens 440 has a positive refractive power, an object-side surface of the fourth lens 440 is concave in a paraxial region thereof, and an image-side surface of the fourth lens 440 is convex in a paraxial region thereof.

The fifth lens 450 has a negative refractive power, an object-side surface of the fifth lens 450 is convex in a paraxial region thereof, and an image-side surface of the fifth lens 450 is concave in a paraxial region thereof.

The sixth lens 460 has a negative refractive power, an object-side surface of the sixth lens 460 is convex in a paraxial region thereof, and an image-side surface of the sixth lens 460 is concave in a paraxial region thereof.

The seventh lens 470 has a positive refractive power, an object-side surface of the seventh lens 470 is convex in a paraxial region thereof, and an image-side surface of the seventh lens 470 is concave in a paraxial region thereof.

The eighth lens 480 has a positive refractive power, and an object-side surface and an image-side surface of the eighth lens 480 are convex in respective paraxial regions thereof.

The ninth lens 490 has a negative refractive power, an object-side surface of the ninth lens 490 is convex in a paraxial region thereof, and an image-side surface of the ninth lens 490 is concave in a paraxial region thereof.

At least one of the third lens 430, the fifth lens 450, the eighth lens 480, and the ninth lens 490 has at least one inflection point on at least one of the object-side surface and the image-side surface thereof.

The surfaces of the first lens 410 to the ninth lens 490 have aspheric coefficients as illustrated in Table 8 below. For example, all of the object-side surfaces and the image-side surfaces of the first lens 410 to the ninth lens 490 are aspherical surfaces.

TABLE 8

| | S1 | S2 | S3 | S4 | S5 | S6 |
|---|---|---|---|---|---|---|
| K | −4.886E−01 | 2.815E+01 | 7.383E+00 | −7.385E+00 | −4.967E+01 | 1.140E+01 |
| A | 8.606E−03 | 3.544E−03 | 2.471E−04 | −5.583E−03 | −5.506E−04 | −1.166E−02 |
| B | −2.459E−02 | 7.388E−03 | −1.662E−02 | 1.927E−02 | −3.769E−02 | 1.825E−02 |
| C | 5.342E−02 | −1.990E−02 | 4.345E−02 | −3.823E−02 | 1.015E−01 | −9.889E−02 |
| D | −7.116E−02 | 2.614E−02 | −7.176E−02 | 3.771E−02 | −1.973E−01 | 2.475E−01 |
| E | 6.337E−02 | −2.178E−02 | 7.970E−02 | −4.786E−03 | 2.570E−01 | −3.873E−01 |
| F | −3.950E−02 | 1.230E−02 | −6.162E−02 | −3.218E−02 | −2.314E−01 | 4.081E−01 |
| G | 1.770E−02 | −4.854E−03 | 3.400E−02 | 4.227E−02 | 1.482E−01 | −3.008E−01 |
| H | −5.780E−03 | 1.358E−03 | −1.355E−02 | −2.894E−02 | −6.846E−02 | 1.583E−01 |
| J | 1.376E−03 | −2.696E−04 | 3.910E−03 | 1.267E−02 | 2.293E−02 | −5.993E−02 |
| L | −2.362E−04 | 3.761E−05 | −8.083E−04 | −3.732E−03 | −5.518E−03 | 1.619E−02 |
| M | 2.844E−05 | −3.585E−06 | 1.167E−04 | 7.389E−04 | 9.304E−04 | −3.047E−03 |
| N | −2.278E−06 | 2.211E−07 | −1.116E−05 | −9.466E−05 | −1.044E−04 | 3.797E−04 |
| O | 1.089E−07 | −7.912E−09 | 6.359E−07 | 7.105E−06 | 6.995E−06 | −2.816E−05 |
| P | −2.351E−09 | 1.238E−10 | −1.633E−08 | −2.377E−07 | −2.121E−07 | 9.402E−07 |

| | S7 | S8 | S9 | S10 | S11 | S12 |
|---|---|---|---|---|---|---|
| K | −4.967E+01 | 1.316E+01 | −5.800E+01 | −1.963E+01 | 4.114E+01 | 3.547E+01 |
| A | −4.658E−03 | 4.246E−02 | 2.641E−02 | 1.624E−02 | −2.725E−02 | −4.413E−02 |
| B | 4.531E−02 | −1.676E−01 | −1.465E−01 | −8.748E−02 | 1.202E−01 | 8.651E−02 |
| C | −1.480E−01 | 3.413E−01 | 2.303E−01 | 1.302E−01 | −2.760E−01 | −1.629E−01 |
| D | 2.846E−01 | −4.764E−01 | −2.649E−01 | −1.492E−01 | 3.601E−01 | 1.550E−01 |
| E | −3.661E−01 | 4.771E−01 | 2.424E−01 | 1.338E−01 | −3.091E−01 | −8.631E−02 |
| F | 3.313E−01 | −3.477E−01 | −1.754E−01 | −9.032E−02 | 1.854E−01 | 2.934E−02 |
| G | −2.171E−01 | 1.854E−01 | 9.781E−02 | 4.487E−02 | −8.002E−02 | −5.569E−03 |
| H | 1.044E−01 | −7.238E−02 | −4.125E−02 | −1.629E−02 | 2.521E−02 | 2.267E−04 |
| J | −3.691E−02 | 2.061E−02 | 1.295E−02 | 4.299E−03 | −5.811E−03 | 1.691E−04 |
| L | 9.472E−03 | −4.216E−03 | −2.964E−03 | −8.131E−04 | 9.696E−04 | −4.862E−05 |
| M | −1.715E−03 | 6.024E−04 | 4.789E−04 | 1.072E−04 | −1.140E−04 | 6.733E−06 |
| N | 2.076E−04 | −5.693E−05 | −5.165E−05 | −9.342E−06 | 8.956E−06 | −5.371E−07 |
| O | −1.505E−05 | 3.191E−06 | 3.331E−06 | 4.823E−07 | −4.217E−07 | 2.365E−08 |
| P | 4.935E−07 | −8.022E−08 | −9.708E−08 | −1.115E−08 | 8.992E−09 | −4.473E−10 |

| | S13 | S14 | S15 | S16 | S17 | S18 |
|---|---|---|---|---|---|---|
| K | 3.683E+01 | 3.809E+01 | −1.193E+01 | −9.897E+01 | 1.725E+01 | −1.017E+01 |
| A | −4.011E−02 | −7.885E−04 | 2.918E−02 | 3.202E−02 | −1.529E−01 | −6.947E−02 |
| B | 4.183E−02 | −8.780E−02 | −4.684E−02 | −2.469E−02 | 7.150E−02 | 3.138E−02 |
| C | −8.621E−02 | 1.112E−01 | 3.574E−02 | 1.519E−02 | −2.428E−02 | −9.741E−03 |
| D | 8.179E−02 | −8.586E−02 | −1.829E−02 | −7.830E−03 | 5.754E−03 | 2.147E−03 |
| E | −3.912E−02 | 4.707E−02 | 6.511E−03 | 2.967E−03 | −8.822E−04 | −3.371E−04 |
| F | 7.996E−03 | −1.894E−02 | −1.650E−03 | −7.893E−04 | 8.095E−05 | 3.790E−05 |
| G | 1.195E−03 | 5.604E−03 | 3.009E−04 | 1.477E−04 | −3.094E−06 | −3.075E−06 |
| H | −1.263E−03 | −1.212E−03 | −3.981E−05 | −1.967E−05 | −2.097E−07 | 1.807E−07 |
| J | 3.933E−04 | 1.901E−04 | 3.822E−06 | 1.871E−06 | 3.859E−08 | −7.674E−09 |
| L | −7.085E−05 | −2.129E−05 | −2.638E−07 | −1.263E−07 | −2.727E−09 | 2.324E−10 |
| M | 8.062E−06 | 1.656E−06 | 1.274E−08 | 5.904E−09 | 1.133E−10 | −4.881E−12 |
| N | −5.733E−07 | −8.489E−08 | −4.089E−10 | −1.817E−10 | −2.881E−12 | 6.733E−14 |
| O | 2.335E−08 | 2.575E−09 | 7.821E−12 | 3.310E−12 | 4.176E−14 | −5.469E−16 |
| P | −4.166E−10 | −3.501E−11 | −6.739E−14 | −2.701E−14 | −2.655E−16 | 1.974E−18 |

The optical imaging system 400 configured as described above may have the aberration characteristics illustrated in FIG. 8.

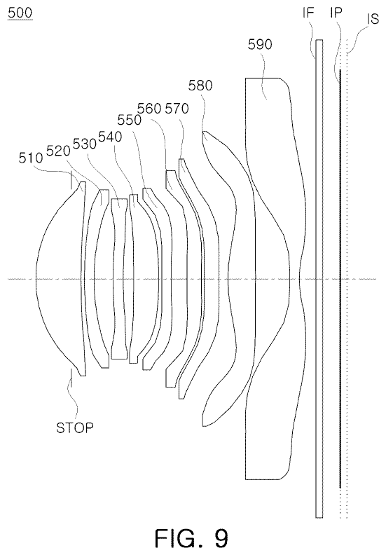

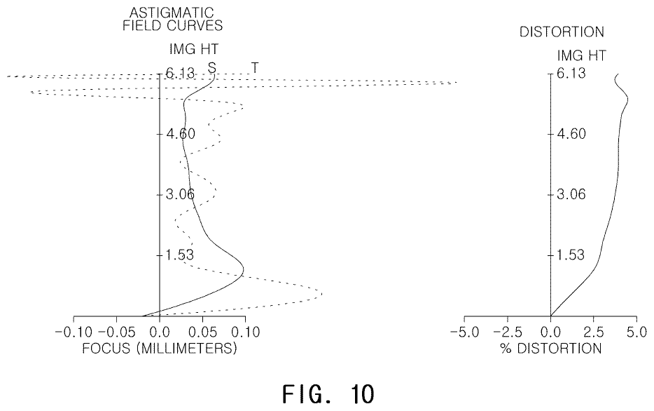

FIG. 9 is a diagram of a configuration of an optical imaging system according to a fifth embodiment, ad FIG. 10 is graphs illustrating aberration characteristics of the optical imaging system illustrated in FIG. 9.

Referring to FIG. 9, an optical imaging system 500 according to the fifth embodiment includes a first lens 510, a second lens 520, a third lens 530, a fourth lens 540, a fifth lens 550, a sixth lens 560, a seventh lens 570, an eighth lens 580, and a ninth lens 590 sequentially disposed in ascending numerical order along an optical axis of the optical imaging system 500 from an object side of the optical imaging system 500 toward an imaging plane IP of the optical imaging system 500, and may further include a filter IF and an image sensor IS disposed after an image-side surface of the ninth lens 590. The imaging plane IP may be formed on a surface of the image sensor IS.

An aperture STOP may be disposed in front of an object-side surface of the first lens 510.

The optical imaging system 500 according to the fifth embodiment may form a focus on the imaging plane IP.

Radiuses of curvature, a thickness of an element, a distance between elements, a refractive index, and an Abbe number of each element of the optical imaging system 500 are illustrated in Table 9 below.

TABLE 9

| Sur- | | | | Refrac- | |
|---|---|---|---|---|---|
| face | | Radius of | Thickness/ | tive | Abbe |
| No. | Element | Curvature | Distance | Index | Number |
| S1 | First | 3.198 | 1.338 | 1.544 | 56.0 |
| S2 | Lens | 30.276 | 0.050 | | |
| S3 | Second | 9.999 | 0.280 | 1.687 | 18.3 |
| S4 | Lens | 5.093 | 0.562 | | |
| S5 | Third | 9.543 | 0.280 | 1.671 | 19.4 |
| S6 | Lens | 8.916 | 0.297 | | |
| S7 | Fourth | −29.522 | 0.702 | 1.544 | 56.0 |
| S8 | Lens | −9.019 | 0.090 | | |
| S9 | Fifth | 20.234 | 0.280 | 1.614 | 26.3 |
| S10 | Lens | 11.223 | 0.463 | | |
| S11 | Sixth | 25.749 | 0.421 | 1.567 | 37.4 |
| S12 | Lens | 18.358 | 0.070 | | |
| S13 | Seventh | 18.764 | 0.407 | 1.544 | 56.0 |
| S14 | Lens | 19.846 | 0.223 | | |
| S15 | Eighth | 4.066 | 0.815 | 1.544 | 56.0 |
| S16 | Lens | −18.429 | 0.955 | | |
| S17 | Ninth | 23.832 | 0.280 | 1.535 | 55.7 |
| S18 | Lens | 2.186 | 0.433 | | |
| S19 | Filter | Infinity | 0.210 | 1.517 | 64.2 |
| S20 | | Infinity | 0.515 | | |
| S21 | Imaging | Infinity | | | |
| | Plane | | | | |

In the fifth embodiment, the first lens 510 has a positive refractive power, an object-side surface of the first lens 510 is convex in a paraxial region thereof, and an image-side surface of the first lens 510 is concave in a paraxial region thereof.

The second lens 520 has a negative refractive power, an object-side surface of the second lens 520 is convex in a paraxial region thereof, and an image-side surface of the second lens 520 is concave in a paraxial region thereof.

The third lens 530 has a negative refractive power, an object-side surface of the third lens 530 is convex in a paraxial region thereof, and an image-side surface of the third lens 530 is concave in a paraxial region thereof.

The fourth lens 540 has a positive refractive power, an object-side surface of the fourth lens 540 is concave in a paraxial region thereof, and an image-side surface of the fourth lens 540 is convex in a paraxial region thereof.

The fifth lens 550 has a negative refractive power, an object-side surface of the fifth lens 550 is convex in a paraxial region thereof, and an image-side surface of the fifth lens 550 is concave in a paraxial region thereof.

The sixth lens 560 has a negative refractive power, an object-side surface of the sixth lens 560 is convex in a paraxial region thereof, and an image-side surface of the sixth lens 560 is concave in a paraxial region thereof.

The seventh lens 570 has a positive refractive power, an object-side surface of the seventh lens 570 is convex in a paraxial region thereof, and an image-side surface of the seventh lens 570 is concave in a paraxial region thereof.

The eighth lens 580 has a positive refractive power, and an object-side surface and an image-side surface of the eighth lens 580 are convex in respective paraxial regions thereof.

The ninth lens 590 has a negative refractive power, an object-side surface of the ninth lens 590 is convex in a paraxial region thereof, and an image-side surface of the ninth lens 590 is concave in a paraxial region thereof.

At least one of the third lens 530, the fifth lens 550, the eighth lens 580, and the ninth lens 590 has at least one inflection point on at least one of the object-side surface and the image-side surface thereof.

The surfaces of the first lens 510 to the ninth lens 590 have aspheric coefficients as illustrated in Table 10 below. For example, all of the object-side surfaces and the image-side surfaces of the first lens 510 to the ninth lens 590 are aspherical surfaces.

TABLE 10

| | S1 | S2 | S3 | S4 | S5 | S6 |
|---|---|---|---|---|---|---|
| K | −4.887E−01 | 2.823E+01 | 7.376E+00 | −7.391E+00 | −4.958E+01 | 1.140E+01 |
| A | 7.994E−03 | 4.041E−03 | 4.294E−04 | −4.896E−03 | −1.181E−03 | −1.114E−02 |
| B | −2.157E−02 | 4.223E−03 | −1.796E−02 | 1.348E−02 | −3.224E−02 | 1.341E−02 |
| C | 4.674E−02 | −1.132E−02 | 4.775E−02 | −1.797E−02 | 8.139E−02 | −7.988E−02 |
| D | −6.254E−02 | 1.306E−02 | −7.940E−02 | −2.256E−03 | −1.549E−01 | 2.053E−01 |
| E | 5.611E−02 | −9.132E−03 | 8.823E−02 | 4.537E−02 | 2.002E−01 | −3.275E−01 |
| F | −3.529E−02 | 4.017E−03 | −6.805E−02 | −7.486E−02 | −1.797E−01 | 3.505E−01 |
| G | 1.597E−02 | −1.040E−03 | 3.740E−02 | 6.781E−02 | 1.151E−01 | −2.617E−01 |
| H | −5.261E−03 | 9.855E−05 | −1.485E−02 | −3.989E−02 | −5.329E−02 | 1.393E−01 |
| J | 1.263E−03 | 3.013E−05 | 4.266E−03 | 1.605E−02 | 1.792E−02 | −5.321E−02 |
| L | −2.186E−04 | −1.346E−05 | −8.787E−04 | −4.477E−03 | −4.334E−03 | 1.450E−02 |
| M | 2.652E−05 | 2.491E−06 | 1.264E−04 | 8.531E−04 | 7.353E−04 | −2.749E−03 |
| N | −2.139E−06 | −2.583E−07 | −1.206E−05 | −1.062E−04 | −8.306E−05 | 3.450E−04 |
| O | 1.029E−07 | 1.465E−08 | 6.850E−07 | 7.800E−06 | 5.612E−06 | −2.574E−05 |
| P | −2.231E−09 | −3.554E−10 | −1.755E−08 | −2.564E−07 | −1.716E−07 | 8.643E−07 |

| | S7 | S8 | S9 | S10 | S11 | S12 |
|---|---|---|---|---|---|---|
| K | −4.980E+01 | 1.316E+01 | −5.816E+01 | −1.959E+01 | 4.148E+01 | 3.546E+01 |
| A | −6.013E−03 | 4.253E−02 | 2.605E−02 | 1.647E−02 | −2.723E−02 | −4.390E−02 |
| B | 5.626E−02 | −1.684E−01 | −1.439E−01 | −8.860E−02 | 1.198E−01 | 8.533E−02 |
| C | −1.876E−01 | 3.449E−01 | 2.224E−01 | 1.333E−01 | −2.748E−01 | −1.604E−01 |
| D | 3.678E−01 | −4.848E−01 | −2.508E−01 | −1.542E−01 | 3.581E−01 | 1.519E−01 |
| E | −4.786E−01 | 4.887E−01 | 2.258E−01 | 1.391E−01 | −3.072E−01 | −8.402E−02 |
| F | 4.351E−01 | −3.584E−01 | −1.618E−01 | −9.404E−02 | 1.842E−01 | 2.819E−02 |
| G | −2.847E−01 | 1.922E−01 | 8.992E−02 | 4.671E−02 | −7.951E−02 | −5.168E−03 |
| H | 1.361E−01 | −7.551E−02 | −3.794E−02 | −1.695E−02 | 2.506E−02 | 1.273E−04 |
| J | −4.758E−02 | 2.164E−02 | 1.195E−02 | 4.466E−03 | −5.776E−03 | 1.866E−04 |
| L | 1.205E−02 | −4.459E−03 | −2.748E−03 | −8.437E−04 | 9.639E−04 | −5.080E−05 |
| M | −2.148E−03 | 6.423E−04 | 4.466E−04 | 1.111E−04 | −1.133E−04 | 6.920E−06 |
| N | 2.558E−04 | −6.129E−05 | −4.845E−05 | −9.671E−06 | 8.905E−06 | −5.475E−07 |
| O | −1.824E−05 | 3.475E−06 | 3.144E−06 | 4.989E−07 | −4.193E−07 | 2.399E−08 |
| P | 5.889E−07 | −8.854E−08 | −9.214E−08 | −1.152E−08 | 8.940E−09 | −4.521E−10 |

| | S13 | S14 | S15 | S16 | S17 | S18 |
|---|---|---|---|---|---|---|
| K | 3.682E+01 | 3.809E+01 | −1.193E+01 | −9.897E+01 | 1.725E+01 | −1.017E+01 |
| A | −3.985E−02 | −7.583E−04 | 2.923E−02 | 3.224E−02 | −1.528E−01 | −6.940E−02 |
| B | 4.108E−02 | −8.773E−02 | −4.697E−02 | −2.508E−02 | 7.139E−02 | 3.132E−02 |
| C | −8.516E−02 | 1.109E−01 | 3.584E−02 | 1.553E−02 | −2.423E−02 | −9.713E−03 |
| D | 8.097E−02 | −8.548E−02 | −1.832E−02 | −8.003E−03 | 5.740E−03 | 2.140E−03 |
| E | −3.877E−02 | 4.679E−02 | 6.511E−03 | 3.024E−03 | −8.794E−04 | −3.356E−04 |
| F | 7.950E−03 | −1.881E−02 | −1.646E−03 | −8.025E−04 | 8.048E−05 | 3.770E−05 |
| G | 1.166E−03 | 5.559E−03 | 2.995E−04 | 1.499E−04 | −3.032E−06 | −3.055E−06 |
| H | −1.244E−03 | −1.202E−03 | −3.952E−05 | −1.992E−05 | −2.158E−07 | 1.793E−07 |
| J | 3.879E−04 | 1.884E−04 | 3.785E−06 | 1.892E−06 | 3.904E−08 | −7.601E−09 |
| L | −6.990E−05 | −2.109E−05 | −2.605E−07 | −1.275E−07 | −2.750E−09 | 2.297E−10 |
| M | 7.955E−06 | 1.640E−06 | 1.256E−08 | 5.956E−09 | 1.141E−10 | −4.812E−12 |
| N | −5.658E−07 | −8.398E−08 | −4.020E−10 | −1.832E−10 | −2.902E−12 | 6.619E−14 |
| O | 2.304E−08 | 2.546E−09 | 7.671E−12 | 3.333E−12 | 4.206E−14 | −5.358E−16 |
| P | −4.110E−10 | −3.459E−11 | −6.596E−14 | −2.718E−14 | −2.675E−16 | 1.925E−18 |

The optical imaging system 500 configured as described above may have the aberration characteristics illustrated in FIG. 10.

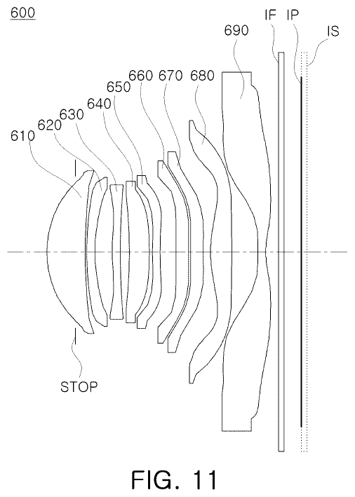

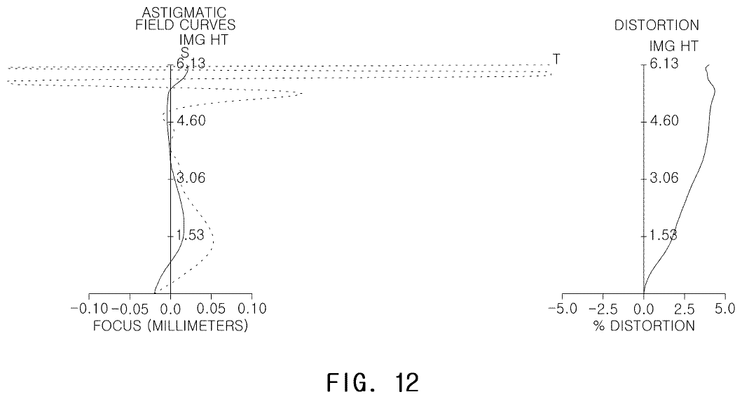

FIG. 11 is a diagram of a configuration of an optical imaging system according to a sixth embodiment, and FIG. 12 is graphs illustrating aberration characteristics of the optical imaging system illustrated in FIG. 11.

Referring to FIG. 11, an optical imaging system 600 according to the sixth embodiment includes a first lens 610, a second lens 620, a third lens 630, a fourth lens 640, a fifth lens 650, a sixth lens 660, a seventh lens 670, an eighth lens 680, and a ninth lens 690 sequentially disposed in ascending numerical order along an optical axis of the optical imaging system 600 from an object side of the optical imaging system 600 toward an imaging plane IP of the optical imaging system 600, and may further include a filter IF and an image sensor IS disposed after an image-side surface of the ninth lens 690. The imaging plane IP may be formed on a surface of the image sensor IS.

An aperture STOP may be disposed in front of an object-side surface of the first lens 610.

The optical imaging system 600 according to the sixth embodiment may form a focus on the imaging plane IP.

Radiuses of curvature, a thickness of an element, a distance between elements, a refractive index, and an Abbe number of each element of the optical imaging system 600 are illustrated in Table 11 below.

TABLE 11

| Sur- | | | | Refrac- | |
|---|---|---|---|---|---|
| face | | Radius of | Thickness/ | tive | Abbe |
| No. | Element | Curvature | Distance | Index | Number |
| S1 | First | 3.203 | 1.352 | 1.544 | 56.0 |
| S2 | Lens | 27.885 | 0.050 | | |
| S3 | Second | 9.637 | 0.280 | 1.687 | 18.3 |
| S4 | Lens | 5.139 | 0.565 | | |
| S5 | Third | 9.681 | 0.280 | 1.671 | 19.4 |
| S6 | Lens | 9.119 | 0.289 | | |
| S7 | Fourth | −28.375 | 0.688 | 1.544 | 56.0 |
| S8 | Lens | −9.180 | 0.085 | | |
| S9 | Fifth | 19.835 | 0.280 | 1.687 | 18.3 |
| S10 | Lens | 12.877 | 0.531 | | |
| S11 | Sixth | 37.655 | 0.403 | 1.614 | 26.3 |
| S12 | Lens | 18.349 | 0.070 | | |
| S13 | Seventh | 18.756 | 0.421 | 1.544 | 56.0 |
| S14 | Lens | 19.850 | 0.257 | | |
| S15 | Eighth | 4.199 | 0.749 | 1.544 | 56.0 |
| S16 | Lens | −14.179 | 0.916 | | |
| S17 | Ninth | 23.384 | 0.280 | 1.535 | 55.7 |
| S18 | Lens | 2.137 | 0.353 | | |
| S19 | Filter | Infinity | 0.210 | 1.517 | 64.2 |
| S20 | | Infinity | 0.612 | | |
| S21 | Imaging | Infinity | | | |
| | Plane | | | | |

In the sixth embodiment, the first lens 610 has a positive refractive power, an object-side surface of the first lens 610 is convex in a paraxial region thereof, and an image-side surface of the first lens 610 is concave in a paraxial region thereof.

The second lens 620 has a negative refractive power, an object-side surface of the second lens 620 is convex in a paraxial region thereof, and an image-side surface of the second lens 620 is concave in a paraxial region thereof.

The third lens 630 has a negative refractive power, an object-side surface of the third lens 630 is convex in a paraxial region thereof, and an image-side surface of the third lens 630 is concave in a paraxial region thereof.

The fourth lens 640 has a positive refractive power, an object-side surface of the fourth lens 640 is concave in a paraxial region thereof, and an image-side surface of the fourth lens 640 is convex in a paraxial region thereof.

The fifth lens 650 has a negative refractive power, an object-side surface of the fifth lens 650 is convex in a paraxial region thereof, and an image-side surface of the fifth lens 650 is concave in a paraxial region thereof.

The sixth lens 660 has a negative refractive power, an object-side surface of the sixth lens 660 is convex in a paraxial region thereof, and an image-side surface of the sixth lens 660 is concave in a paraxial region thereof.

The seventh lens 670 has a positive refractive power, an object-side surface of the seventh lens 670 is convex in a paraxial region thereof, and an image-side surface of the seventh lens 670 is concave in a paraxial region thereof.

The eighth lens 680 has a positive refractive power, and an object-side surface and an image-side surface of the eighth lens 680 are convex in respective paraxial regions thereof.

The ninth lens 690 has a negative refractive power, an object-side surface of the ninth lens 690 is convex in the paraxial region thereof, and an image-side surface of the ninth lens 690 is concave in the paraxial region thereof.

At least one of the third lens 630, the fifth lens 650, the eighth lens 680, and the ninth lens 690 has at least one inflection point on at least one of the object-side surface and the image-side surface thereof.

The surfaces of the first lens 610 to the ninth lens 690 have aspheric coefficients as illustrated in Table 12 below. For example, all of the object-side surfaces and the image-side surfaces of the first lens 610 to the ninth lens 690 are aspherical surfaces.

TABLE 12

| | S1 | S2 | S3 | S4 | S5 | S6 |
|---|---|---|---|---|---|---|
| K | −4.934E−01 | 1.658E+01 | 4.807E+00 | −7.952E+00 | −5.296E+01 | 1.110E+01 |
| A | −1.522E−03 | 5.791E−03 | −1.065E−03 | −1.484E−03 | −4.699E−03 | −5.237E−03 |
| B | 1.477E−02 | 3.930E−03 | −6.171E−03 | −2.122E−03 | −1.468E−02 | −3.725E−02 |
| C | −3.078E−02 | −1.168E−02 | 1.920E−02 | 1.984E−02 | 1.650E−02 | 1.140E−01 |
| D | 4.041E−02 | 1.170E−02 | −3.834E−02 | −5.697E−02 | −1.365E−02 | −2.416E−01 |
| E | −3.532E−02 | −6.696E−03 | 4.604E−02 | 9.347E−02 | 3.888E−03 | 3.431E−01 |
| F | 2.149E−02 | 2.237E−03 | −3.583E−02 | −9.976E−02 | 5.094E−03 | −3.369E−01 |
| G | −9.348E−03 | −3.096E−04 | 1.909E−02 | 7.331E−02 | −7.122E−03 | 2.348E−01 |
| H | 2.947E−03 | −7.431E−05 | −7.160E−03 | −3.805E−02 | 4.509E−03 | −1.178E−01 |
| J | −6.748E−04 | 4.845E−05 | 1.909E−03 | 1.406E−02 | −1.759E−03 | 4.265E−02 |
| L | 1.112E−04 | −1.185E−05 | −3.594E−04 | −3.681E−03 | 4.486E−04 | −1.105E−02 |
| M | −1.284E−05 | 1.659E−06 | 4.667E−05 | 6.670E−04 | −7.452E−05 | 1.996E−03 |
| N | 9.877E−07 | −1.373E−07 | −3.969E−06 | −7.959E−05 | 7.685E−06 | −2.386E−04 |
| O | −4.542E−08 | 6.159E−09 | 1.987E−07 | 5.631E−06 | −4.371E−07 | 1.697E−05 |
| P | 9.447E−10 | −1.122E−10 | −4.425E−09 | −1.790E−07 | 1.001E−08 | −5.434E−07 |

| | S7 | S8 | S9 | S10 | S11 | S12 |
|---|---|---|---|---|---|---|
| K | −8.250E+01 | 1.312E+01 | −4.689E+01 | −2.159E+01 | 8.551E+01 | 3.499E+01 |
| A | 1.494E−03 | 3.256E−02 | 2.500E−02 | 1.110E−02 | 4.650E−03 | −2.910E−02 |
| B | 6.818E−03 | −1.302E−01 | −1.424E−01 | −6.813E−02 | −2.257E−02 | 3.815E−02 |
| C | −2.657E−02 | 2.509E−01 | 2.380E−01 | 9.047E−02 | 2.253E−02 | −1.030E−01 |
| D | 4.905E−02 | −3.311E−01 | −2.915E−01 | −9.014E−02 | −2.457E−02 | 1.181E−01 |
| E | −5.729E−02 | 3.152E−01 | 2.779E−01 | 7.233E−02 | 2.552E−02 | −7.731E−02 |
| F | 4.357E−02 | −2.196E−01 | −2.059E−01 | −4.629E−02 | −1.999E−02 | 3.254E−02 |
| G | −2.158E−02 | 1.121E−01 | 1.165E−01 | 2.287E−02 | 1.104E−02 | −9.259E−03 |
| H | 6.576E−03 | −4.176E−02 | −4.964E−02 | −8.498E−03 | −4.289E−03 | 1.816E−03 |
| J | −9.289E−04 | 1.125E−02 | 1.569E−02 | 2.330E−03 | 1.177E−03 | −2.460E−04 |
| L | −1.076E−04 | −2.150E−03 | −3.604E−03 | −4.615E−04 | −2.271E−04 | 2.271E−05 |
| M | 7.661E−05 | 2.806E−04 | 5.832E−04 | 6.393E−05 | 3.018E−05 | −1.397E−06 |
| N | −1.526E−05 | −2.337E−05 | −6.288E−05 | −5.861E−06 | −2.630E−06 | 5.597E−08 |
| O | 1.465E−06 | 1.084E−06 | 4.049E−06 | 3.187E−07 | 1.355E−07 | −1.451E−09 |
| P | −5.735E−08 | −1.991E−08 | −1.176E−07 | −7.770E−09 | −3.130E−09 | 2.210E−11 |

| | S13 | S14 | S15 | S16 | S17 | S18 |
|---|---|---|---|---|---|---|
| K | 3.689E+01 | 3.808E+01 | −1.157E+01 | −9.897E+01 | 1.763E+01 | −8.483E+00 |
| A | −3.557E−02 | −1.850E−02 | 2.388E−02 | 2.674E−02 | −1.465E−01 | −7.071E−02 |
| B | 3.966E−02 | −3.087E−02 | −2.977E−02 | −1.449E−02 | 5.895E−02 | 2.917E−02 |
| C | −9.759E−02 | 2.796E−02 | 1.440E−02 | 2.139E−03 | −1.585E−02 | −7.718E−03 |
| D | 1.058E−01 | −1.289E−02 | −3.317E−03 | 1.541E−03 | 2.789E−03 | 1.407E−03 |
| E | −6.190E−02 | 4.505E−03 | −1.206E−04 | −1.160E−03 | −2.547E−04 | −1.787E−04 |
| F | 2.113E−02 | −1.635E−03 | 3.212E−04 | 4.080E−04 | −4.951E−06 | 1.573E−05 |
| G | −3.878E−03 | 5.840E−04 | −1.060E−04 | −9.151E−05 | 4.790E−06 | −9.340E−07 |
| H | 1.114E−04 | −1.633E−04 | 1.965E−05 | 1.405E−05 | −6.999E−07 | 3.452E−08 |
| J | 1.276E−04 | 3.220E−05 | −2.366E−06 | −1.509E−06 | 5.887E−08 | −5.477E−10 |
| L | −3.426E−05 | −4.352E−06 | 1.918E−07 | 1.131E−07 | −3.248E−09 | −1.408E−11 |
| M | 4.554E−06 | 3.942E−07 | −1.043E−08 | −5.807E−09 | 1.199E−10 | 1.031E−12 |
| N | −3.508E−07 | −2.290E−08 | 3.661E−10 | 1.944E−10 | −2.862E−12 | −2.617E−14 |
| O | 1.496E−08 | 7.722E−10 | −7.503E−12 | −3.823E−12 | 4.012E−14 | 3.304E−16 |
| P | −2.744E−10 | −1.150E−11 | 6.832E−14 | 3.352E−14 | −2.513E−16 | −1.726E−18 |

The optical imaging system 600 configured as described above may have the aberration characteristics illustrated in FIG. 12.

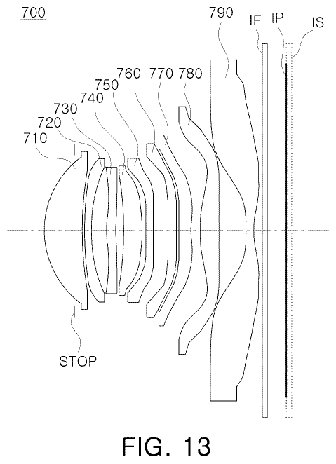

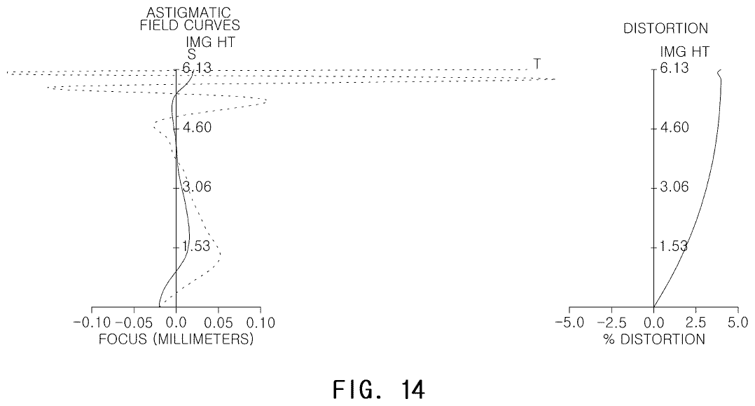

FIG. 13 is a diagram of a configuration of an optical imaging system according to a seventh embodiment, and FIG. 14 is graphs illustrating aberration characteristics of the optical imaging system illustrated in FIG. 13.

Referring to FIG. 13, an optical imaging system 700 according to the seventh embodiment includes a first lens 710, a second lens 720, a third lens 730, a fourth lens 740, a fifth lens 750, a sixth lens 760, a seventh lens 770, an eighth lens 780, and a ninth lens 790 sequentially disposed in ascending numerical order along an optical axis of the optical imaging system 700 from an object side of the optical imaging system 700 toward an imaging plane IP of the optical imaging system 700, and may further include a filter IF and an image sensor IS disposed after an image-side surface of the ninth lens 790. The imaging plane IP may be formed on a surface of the image sensor IS.

An aperture STOP may be disposed in front of an object-side surface of the first lens 710.

The optical imaging system 700 according to the seventh embodiment may form a focus on the imaging plane IP.

Radiuses of curvature, a thickness of an element, a distance between elements, a refractive index, and an Abbe number of each element of the optical imaging system 700 are illustrated in Table 13 below.

TABLE 13

| Sur- | | | | Refrac- | |
|---|---|---|---|---|---|
| face | | Radius of | Thickness/ | tive | Abbe |
| No. | Element | Curvature | Distance | Index | Number |
| S1 | First | 3.190 | 1.409 | 1.544 | 56.0 |
| S2 | Lens | 28.491 | 0.050 | | |
| S3 | Second | 9.338 | 0.280 | 1.687 | 18.3 |
| S4 | Lens | 4.896 | 0.568 | | |
| S5 | Third | 9.312 | 0.280 | 1.671 | 19.4 |
| S6 | Lens | 9.879 | 0.298 | | |
| S7 | Fourth | −22.622 | 0.644 | 1.544 | 56.0 |
| S8 | Lens | −9.024 | 0.121 | | |
| S9 | Fifth | 58.993 | 0.280 | 1.687 | 18.3 |
| S10 | Lens | 19.561 | 0.473 | | |
| S11 | Sixth | 30.972 | 0.373 | 1.614 | 26.3 |
| S12 | Lens | 18.317 | 0.072 | | |
| S13 | Seventh | 18.720 | 0.443 | 1.544 | 56.0 |
| S14 | Lens | 19.846 | 0.299 | | |
| S15 | Eighth | 4.102 | 0.673 | 1.544 | 56.0 |
| S16 | Lens | −18.675 | 0.959 | | |
| S17 | Ninth | 23.586 | 0.280 | 1.535 | 55.7 |
| S18 | Lens | 2.149 | 0.289 | | |
| S19 | Filter | Infinity | 0.210 | 1.517 | 64.2 |
| S20 | | Infinity | 0.670 | | |
| S21 | Imaging | Infinity | | | |
| | Plane | | | | |

In the seventh embodiment, the first lens 710 has a positive refractive power, an object-side surface of the first lens 710 is convex in a paraxial region thereof, and an image-side surface of the first lens 710 is concave in a paraxial region thereof.

The second lens 720 has a negative refractive power, an object-side surface of the second lens 720 is convex in a paraxial region thereof, and an image-side surface of the second lens 720 is concave in a paraxial region thereof.

The third lens 730 has a positive refractive power, an object-side surface of the third lens 730 is convex in a paraxial region thereof, and an image-side surface of the third lens 730 is concave in a paraxial region thereof.

The fourth lens 740 has a positive refractive power, an object-side surface of the fourth lens 740 is concave in a paraxial region thereof, and an image-side surface of the fourth lens 740 is convex in a paraxial region thereof.

The fifth lens 750 has a negative refractive power, an object-side surface of the fifth lens 750 is convex in a paraxial region thereof, and an image-side surface of the fifth lens 750 is concave in a paraxial region thereof.

The sixth lens 760 has a negative refractive power, an object-side surface of the sixth lens 760 is convex in a paraxial region thereof, and an image-side surface of the sixth lens 760 is concave in a paraxial region thereof.

The seventh lens 770 has a positive refractive power, an object-side surface of the seventh lens 770 is convex in a paraxial region thereof, and an image-side surface of the seventh lens 770 is concave in a paraxial region thereof.

The eighth lens 780 has a positive refractive power, and an object-side surface and an image-side surface of the eighth lens 780 are convex in respective paraxial regions thereof.

The ninth lens 790 has a negative refractive power, an object-side surface of the ninth lens 790 is convex in a paraxial region thereof, and an image-side surface of the ninth lens 790 is concave in a paraxial region thereof.

At least one of the third lens 730, the fifth lens 750, the eighth lens 780, and the ninth lens 790 has at least one inflection point on at least one of the object-side surface and the image-side surface thereof.

The surfaces of the first lens 710 to the ninth lens 790 have aspheric coefficients as illustrated in Table 14 below. For example, all of the object-side surfaces and the image-side surfaces of the first lens 710 to the ninth lens 790 are aspherical surfaces.

TABLE 14

| | S1 | S2 | S3 | S4 | S5 | S6 |
|---|---|---|---|---|---|---|
| K | −4.649E−01 | 1.830E+01 | 2.359E+00 | −7.735E+00 | −4.239E+01 | 1.177E+01 |
| A | −1.729E−03 | 6.665E−03 | −2.523E−03 | −3.803E−03 | −4.950E−03 | −2.812E−03 |
| B | 1.508E−02 | 1.305E−03 | −3.584E−03 | 7.910E−03 | −9.639E−03 | −4.536E−02 |
| C | −3.177E−02 | −6.521E−03 | 1.305E−02 | −8.809E−03 | 3.576E−03 | 1.440E−01 |
| D | 4.278E−02 | 3.957E−03 | −3.059E−02 | −6.252E−03 | 9.257E−03 | −3.121E−01 |
| E | −3.861E−02 | 1.506E−03 | 4.067E−02 | 3.447E−02 | −2.609E−02 | 4.528E−01 |
| F | 2.434E−02 | −3.792E−03 | −3.405E−02 | −5.294E−02 | 3.373E−02 | −4.557E−01 |
| G | −1.098E−02 | 2.806E−03 | 1.929E−02 | 4.759E−02 | −2.709E−02 | 3.265E−01 |
| H | 3.585E−03 | −1.223E−03 | −7.663E−03 | −2.829E−02 | 1.469E−02 | −1.689E−01 |
| J | −8.496E−04 | 3.523E−04 | 2.164E−03 | 1.157E−02 | −5.533E−03 | 6.316E−02 |
| L | 1.445E−04 | −6.906E−05 | −4.328E−04 | −3.279E−03 | 1.452E−03 | −1.693E−02 |
| M | −1.719E−05 | 9.143E−06 | 5.993E−05 | 6.335E−04 | −2.601E−04 | 3.168E−03 |
| N | 1.356E−06 | −7.837E−07 | −5.464E−06 | −7.965E−05 | 3.032E−05 | −3.929E−04 |
| O | −6.375E−08 | 3.930E−08 | 2.951E−07 | 5.879E−06 | −2.070E−06 | 2.903E−05 |
| P | 1.351E−09 | −8.755E−10 | −7.146E−09 | −1.933E−07 | 6.265E−08 | −9.666E−07 |

| | S7 | S8 | S9 | S10 | S11 | S12 |
|---|---|---|---|---|---|---|
| K | −1.514E+00 | 1.345E+01 | −7.543E+01 | −2.942E+01 | 7.161E+00 | 3.411E+01 |
| A | 3.253E−04 | 2.289E−02 | 2.166E−02 | 1.371E−02 | −8.904E−04 | −3.838E−02 |
| B | 1.584E−02 | −9.022E−02 | −1.269E−01 | −7.107E−02 | −1.070E−02 | 6.904E−02 |
| C | −7.081E−02 | 1.697E−01 | 2.203E−01 | 9.462E−02 | 1.385E−04 | −1.631E−01 |
| D | 1.632E−01 | −2.311E−01 | −3.035E−01 | −9.865E−02 | 2.346E−03 | 1.942E−01 |
| E | −2.392E−01 | 2.350E−01 | 3.333E−01 | 8.412E−02 | 4.801E−03 | −1.419E−01 |
| F | 2.375E−01 | −1.777E−01 | −2.800E−01 | −5.688E−02 | −9.554E−03 | 7.009E−02 |
| G | −1.657E−01 | 9.895E−02 | 1.752E−01 | 2.931E−02 | 7.666E−03 | −2.451E−02 |
| H | 8.274E−02 | −4.034E−02 | −8.057E−02 | −1.123E−02 | −3.678E−03 | 6.204E−03 |
| J | −2.974E−02 | 1.194E−02 | 2.701E−02 | 3.144E−03 | 1.164E−03 | −1.144E−03 |
| L | 7.630E−03 | −2.524E−03 | −6.500E−03 | −6.319E−04 | −2.503E−04 | 1.525E−04 |
| M | −1.364E−03 | 3.694E−04 | 1.092E−03 | 8.840E−05 | 3.633E−05 | −1.436E−05 |
| N | 1.612E−04 | −3.538E−05 | −1.214E−04 | −8.153E−06 | −3.416E−06 | 9.063E−07 |
| O | −1.134E−05 | 1.982E−06 | 8.026E−06 | 4.446E−07 | 1.881E−07 | −3.442E−08 |
| P | 3.592E−07 | −4.880E−08 | −2.385E−07 | −1.084E−08 | −4.607E−09 | 5.949E−10 |

| | S13 | S14 | S15 | S16 | S17 | S18 |
|---|---|---|---|---|---|---|
| K | 3.699E+01 | 3.808E+01 | −1.148E+01 | −9.897E+01 | 1.748E+01 | −8.745E+00 |
| A | −3.953E−02 | −2.413E−02 | 2.230E−02 | 2.931E−02 | −1.486E−01 | −7.253E−02 |
| B | 6.228E−02 | −2.151E−02 | −2.695E−02 | −1.541E−02 | 5.996E−02 | 3.041E−02 |
| C | −1.402E−01 | 2.011E−02 | 1.246E−02 | 1.905E−03 | −1.467E−02 | −7.971E−03 |
| D | 1.591E−01 | −7.533E−03 | −2.204E−03 | 2.505E−03 | 1.722E−03 | 1.377E−03 |
| E | −1.078E−01 | 1.010E−03 | −6.757E−04 | −1.902E−03 | 1.175E−04 | −1.570E−04 |
| F | 4.805E−02 | 1.865E−04 | 5.230E−04 | 6.986E−04 | −7.988E−05 | 1.127E−05 |
| G | −1.472E−02 | −8.323E−05 | −1.561E−04 | −1.615E−04 | 1.469E−05 | −4.095E−07 |
| H | 3.153E−03 | 4.427E−06 | 2.820E−05 | 2.526E−05 | −1.609E−06 | −5.982E−09 |
| J | −4.714E−04 | 3.167E−06 | −3.376E−06 | −2.743E−06 | 1.183E−07 | 1.606E−09 |
| L | 4.819E−05 | −8.866E−07 | 2.746E−07 | 2.071E−07 | −6.014E−09 | −9.403E−11 |
| M | −3.215E−06 | 1.136E−07 | −1.505E−08 | −1.068E−08 | 2.098E−10 | 3.075E−12 |
| N | 1.267E−07 | −8.133E−09 | 5.336E−10 | 3.591E−10 | −4.811E−12 | −6.060E−14 |
| O | −2.287E−09 | 3.152E−10 | −1.106E−11 | −7.092E−12 | 6.538E−14 | 6.751E−16 |
| P | 3.279E−12 | −5.177E−12 | 1.020E−13 | 6.245E−14 | −3.997E−16 | −3.282E−18 |

The optical imaging system 700 configured as described above may have the aberration characteristics illustrated in FIG. 14.

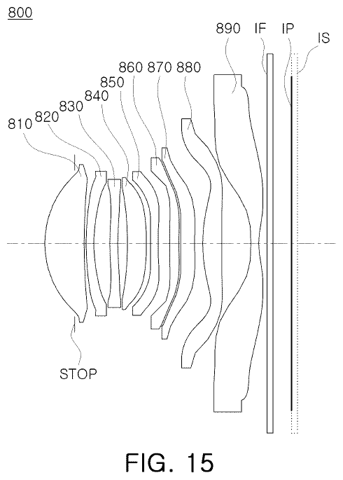

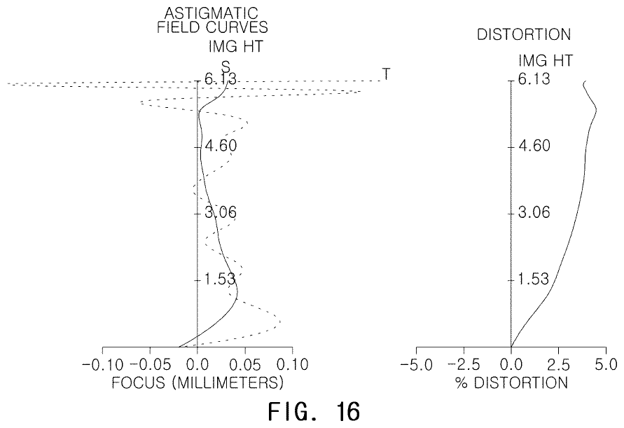

FIG. 15 is a diagram of a configuration of an optical imaging system according to an eighth embodiment, and FIG. 16 is graphs illustrating aberration characteristics of the optical imaging system illustrated in FIG. 15.

Referring to FIG. 15, an optical imaging system 800 according to the eighth embodiment includes a first lens 810, a second lens 820, a third lens 830, a fourth lens 840, a fifth lens 850, a sixth lens 860, a seventh lens 870, an eighth lens 880, and a ninth lens 890 sequentially disposed in ascending numerical order along an optical axis of the optical imaging system 800 from an object side of the optical imaging system 800 toward an imaging plane IP of the optical imaging system 800, and may further include a filter IF and an image sensor IS disposed after an image-side surface of the ninth lens 890. The imaging plane IP may be formed on a surface of the image sensor IS.

An aperture STOP may be disposed in front of an object-side surface of the first lens 810.

The optical imaging system 800 according to the eighth embodiment may form a focus on the imaging plane IP.

Radiuses of curvature, a thickness of an element, a distance between elements, a refractive index, and an Abbe number of each element of the optical imaging system 800 are illustrated in Table 15 below.

TABLE 15

| Sur- | | | | Refrac- | |
|---|---|---|---|---|---|
| face | | Radius of | Thickness/ | tive | Abbe |
| No. | Element | Curvature | Distance | Index | Number |
| S1 | First | 3.202 | 1.391 | 1.544 | 56.0 |
| S2 | Lens | 34.642 | 0.050 | | |
| S3 | Second | 9.415 | 0.280 | 1.687 | 18.3 |
| S4 | Lens | 4.746 | 0.560 | | |
| S5 | Third | 9.052 | 0.280 | 1.671 | 19.4 |
| S6 | Lens | 9.580 | 0.333 | | |
| S7 | Fourth | −23.327 | 0.672 | 1.544 | 56.0 |
| S8 | Lens | −8.912 | 0.146 | | |
| S9 | Fifth | 58.418 | 0.280 | 1.614 | 26.3 |
| S10 | Lens | 15.480 | 0.390 | | |
| S11 | Sixth | 22.070 | 0.354 | 1.567 | 37.4 |
| S12 | Lens | 18.131 | 0.070 | | |
| S13 | Seventh | 18.610 | 0.462 | 1.544 | 56.0 |
| S14 | Lens | 19.940 | 0.282 | | |
| S15 | Eighth | 3.821 | 0.668 | 1.544 | 56.0 |
| S16 | Lens | −52.557 | 1.022 | | |
| S17 | Ninth | 25.459 | 0.280 | 1.535 | 55.7 |
| S18 | Lens | 2.261 | 0.289 | | |
| S19 | Filter | Infinity | 0.210 | 1.517 | 64.2 |
| S20 | | Infinity | 0.654 | | |
| S21 | Imaging | Infinity | | | |
| | Plane | | | | |

In the eighth embodiment, the first lens 810 has a positive refractive power, an object-side surface of the first lens 810 is convex in a paraxial region thereof, and an image-side surface of the first lens 810 is concave in a paraxial region thereof.

The second lens 820 has a negative refractive power, an object-side surface of the second lens 820 is convex in a paraxial region thereof, and an image-side surface of the second lens 820 is concave in a paraxial region thereof.

The third lens 830 has a positive refractive power, an object-side surface of the third lens 830 is convex in a paraxial region thereof, and an image-side surface of the third lens 830 is concave in a paraxial region thereof.

The fourth lens 840 has a positive refractive power, an object-side surface of the fourth lens 840 is concave in a paraxial region thereof, and an image-side surface of the fourth lens 840 is convex in a paraxial region thereof.

The fifth lens 850 has a negative refractive power, an object-side surface of the fifth lens 850 is convex in a paraxial region thereof, and an image-side surface of the fifth lens 850 is concave in a paraxial region thereof.

The sixth lens 860 has a negative refractive power, an object-side surface of the sixth lens 860 is convex in a paraxial region thereof, and an image-side surface of the sixth lens 860 is concave in a paraxial region thereof.

The seventh lens 870 has a positive refractive power, an object-side surface of the seventh lens 870 is convex in a paraxial region thereof, and an image-side surface of the seventh lens 870 is concave in a paraxial region thereof.

The eighth lens 880 has a positive refractive power, and an object-side surface and an image-side surface of the eighth lens 880 are convex in respective paraxial regions thereof.

The ninth lens 890 has a negative refractive power, an object-side surface of the ninth lens 890 is convex in a paraxial region thereof, and an image-side surface of the ninth lens 890 is concave in a paraxial region thereof.

At least one of the third lens 830, the fifth lens 850, the eighth lens 880, and the ninth lens 890 has at least one inflection point on at least one of the object-side surface and the image-side surface thereof.

The surfaces of the first lens 810 to the ninth lens 890 have aspheric coefficients as illustrated in Table 16 below. For example, all of the object-side surfaces and the image-side surfaces of the first lens 810 to the ninth lens 890 are aspherical surfaces.

TABLE 16

| | S1 | S2 | S3 | S4 | S5 | S6 |
|---|---|---|---|---|---|---|
| K | −5.132E−01 | −9.628E+00 | 3.246E+00 | −8.051E+00 | −4.269E+01 | 1.336E+01 |
| A | 6.498E−03 | 4.862E−03 | −4.443E−03 | −7.102E−03 | −8.142E−03 | −7.031E−04 |
| B | −1.687E−02 | 2.383E−03 | −2.168E−03 | 3.295E−02 | 4.045E−03 | −4.625E−02 |
| C | 3.749E−02 | −1.370E−02 | −2.674E−03 | −1.019E−01 | −1.438E−02 | 1.173E−01 |
| D | −5.029E−02 | 2.305E−02 | 1.555E−02 | 1.974E−01 | 6.790E−03 | −2.012E−01 |
| E | 4.473E−02 | −2.247E−02 | −2.379E−02 | −2.509E−01 | 1.444E−02 | 2.324E−01 |
| F | −2.767E−02 | 1.433E−02 | 2.065E−02 | 2.200E−01 | −2.901E−02 | −1.870E−01 |
| G | 1.224E−02 | −6.307E−03 | −1.171E−02 | −1.372E−01 | 2.648E−02 | 1.074E−01 |
| H | −3.923E−03 | 1.966E−03 | 4.580E−03 | 6.185E−02 | −1.508E−02 | −4.434E−02 |
| J | 9.135E−04 | −4.379E−04 | −1.261E−03 | −2.024E−02 | 5.791E−03 | 1.311E−02 |
| L | −1.528E−04 | 6.936E−05 | 2.443E−04 | 4.758E−03 | −1.529E−03 | −2.719E−03 |
| M | 1.790E−05 | −7.635E−06 | −3.262E−05 | −7.838E−04 | 2.744E−04 | 3.805E−04 |
| N | −1.392E−06 | 5.556E−07 | 2.861E−06 | 8.584E−05 | −3.202E−05 | −3.323E−05 |
| O | 6.457E−08 | −2.405E−08 | −1.483E−07 | −5.611E−06 | 2.192E−06 | 1.543E−06 |
| P | −1.351E−09 | 4.694E−10 | 3.442E−09 | 1.656E−07 | −6.677E−08 | −2.442E−08 |

| | S7 | S8 | S9 | S10 | S11 | S12 |
|---|---|---|---|---|---|---|
| K | 2.201E+01 | 1.347E+01 | −9.000E+01 | −2.807E+01 | 3.862E+01 | 3.753E+01 |
| A | 2.018E−04 | 1.821E−02 | 2.405E−02 | 1.960E−02 | −5.460E−03 | 2.071E−02 |
| B | 2.197E−02 | −5.971E−02 | −1.168E−01 | −6.006E−02 | 3.852E−02 | −1.383E−01 |
| C | −9.807E−02 | 7.401E−02 | 1.757E−01 | 3.911E−02 | −1.166E−01 | 2.019E−01 |
| D | 2.200E−01 | −4.600E−02 | −2.273E−01 | −8.613E−04 | 1.649E−01 | −1.923E−01 |
| E | −3.152E−01 | −6.510E−03 | 2.497E−01 | −2.268E−02 | −1.489E−01 | 1.238E−01 |
| F | 3.106E−01 | 4.295E−02 | −2.123E−01 | 2.451E−02 | 9.253E−02 | −5.439E−02 |
| G | −2.186E−01 | −4.481E−02 | 1.334E−01 | −1.539E−02 | −4.067E−02 | 1.655E−02 |
| H | 1.117E−01 | 2.710E−02 | −6.123E−02 | 6.580E−03 | 1.278E−02 | −3.524E−03 |
| J | −4.159E−02 | −1.086E−02 | 2.040E−02 | −1.986E−03 | −2.875E−03 | 5.250E−04 |
| L | 1.115E−02 | 2.970E−03 | −4.868E−03 | 4.238E−04 | 4.583E−04 | −5.379E−05 |
| M | −2.096E−03 | −5.506E−04 | 8.102E−04 | −6.272E−05 | −5.047E−05 | 3.638E−06 |
| N | 2.618E−04 | 6.626E−05 | −8.919E−05 | 6.131E−06 | 3.642E−06 | −1.493E−07 |
| O | −1.952E−05 | −4.676E−06 | 5.832E−06 | −3.566E−07 | −1.546E−07 | 3.078E−09 |
| P | 6.563E−07 | 1.470E−07 | −1.714E−07 | 9.351E−09 | 2.919E−09 | −1.692E−11 |

| | S13 | S14 | S15 | S16 | S17 | S18 |
|---|---|---|---|---|---|---|
| K | 3.681E+01 | 3.792E+01 | −1.032E+01 | −9.897E+01 | 1.845E+01 | −1.053E+01 |
| A | 2.843E−02 | −2.778E−03 | 2.495E−02 | 3.427E−02 | −1.464E−01 | −6.710E−02 |
| B | −1.828E−01 | −9.395E−02 | −3.514E−02 | −2.155E−02 | 6.633E−02 | 2.965E−02 |
| C | 2.720E−01 | 1.308E−01 | 2.397E−02 | 1.004E−02 | −2.112E−02 | −8.932E−03 |
| D | −2.531E−01 | −1.074E−01 | −1.095E−02 | −3.935E−03 | 4.386E−03 | 1.869E−03 |
| E | 1.607E−01 | 6.052E−02 | 3.356E−03 | 1.094E−03 | −5.243E−04 | −2.739E−04 |
| F | −7.124E−02 | −2.442E−02 | −6.962E−04 | −1.957E−04 | 2.235E−05 | 2.845E−05 |
| G | 2.236E−02 | 7.150E−03 | 9.730E−05 | 2.003E−05 | 3.242E−06 | −2.116E−06 |
| H | −5.027E−03 | −1.526E−03 | −8.933E−06 | −5.788E−07 | −6.775E−07 | 1.129E−07 |
| J | 8.125E−04 | 2.368E−04 | 4.973E−07 | −1.325E−07 | 6.250E−08 | −4.275E−09 |
| L | −9.375E−05 | −2.637E−05 | −1.169E−08 | 2.087E−08 | −3.568E−09 | 1.121E−10 |
| M | 7.546E−06 | 2.050E−06 | −3.932E−10 | −1.502E−09 | 1.331E−10 | −1.927E−12 |
| N | −4.030E−07 | −1.054E−07 | 3.879E−11 | 6.162E−11 | −3.175E−12 | 1.940E−14 |
| O | 1.284E−08 | 3.221E−09 | −1.160E−12 | −1.392E−12 | 4.418E−14 | −8.375E−17 |
| P | −1.848E−10 | −4.423E−11 | 1.298E−14 | 1.353E−14 | −2.736E−16 | −4.724E−20 |

The optical imaging system 800 configured as described above may have the aberration characteristics illustrated in FIG. 16.

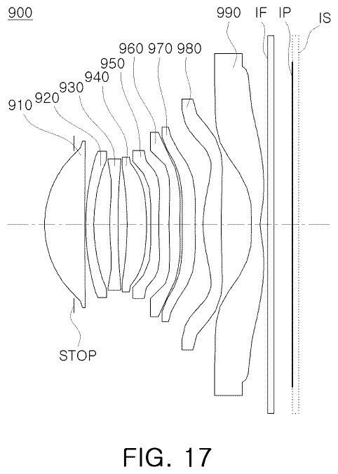

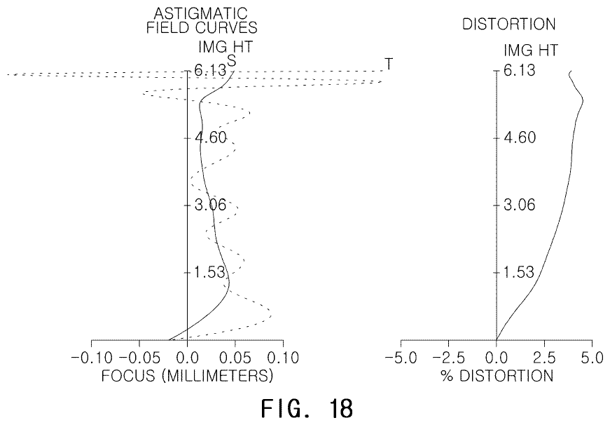

FIG. 17 is a diagram of a configuration of an optical imaging system according to a ninth embodiment, and FIG. 18 is graphs illustrating aberration characteristics of the optical imaging system illustrated in FIG. 17.

Referring to FIG. 17, an optical imaging system 900 according to the ninth embodiment includes a first lens 910, a second lens 920, a third lens 930, a fourth lens 940, a fifth lens 950, a sixth lens 960, a seventh lens 970, an eighth lens 980, and a ninth lens 990 sequentially disposed in ascending numerical order along an optical axis of the optical imaging system 900 from an object side of the optical imaging system 900 toward an imaging plane IP of the optical imaging system 900, and may further include a filter IF and an image sensor IS disposed after an image-side surface of the ninth lens 990. The imaging plane IP may be formed on a surface of the image sensor IS.

An aperture STOP may be disposed in front of an object-side surface of the first lens 910.

The optical imaging system 900 according to the ninth embodiment may form a focus on the imaging plane IP.

Radiuses of curvature, a thickness of an element, a distance between elements, a refractive index, and an Abbe number of each element of the optical imaging system 900 are illustrated in Table 17 below.

TABLE 17

| Sur- | | | | Refrac- | |
|---|---|---|---|---|---|
| face | | Radius of | Thickness/ | tive | Abbe |
| No. | Element | Curvature | Distance | Index | Number |
| S1 | First | 3.202 | 1.391 | 1.544 | 56.0 |
| S2 | Lens | 34.556 | 0.050 | | |
| S3 | Second | 9.410 | 0.280 | 1.687 | 18.3 |
| S4 | Lens | 4.729 | 0.560 | | |
| S5 | Third | 8.991 | 0.280 | 1.671 | 19.4 |
| S6 | Lens | 9.585 | 0.333 | | |
| S7 | Fourth | −23.292 | 0.672 | 1.544 | 56.0 |
| S8 | Lens | −8.911 | 0.146 | | |
| S9 | Fifth | 58.526 | 0.280 | 1.614 | 26.3 |
| S10 | Lens | 15.493 | 0.391 | | |
| S11 | Sixth | 22.082 | 0.354 | 1.567 | 37.4 |
| S12 | Lens | 18.131 | 0.070 | | |
| S13 | Seventh | 18.611 | 0.461 | 1.544 | 56.0 |
| S14 | Lens | 19.941 | 0.282 | | |
| S15 | Eighth | 3.821 | 0.668 | 1.544 | 56.0 |
| S16 | Lens | −52.537 | 1.022 | | |
| S17 | Ninth | 25.457 | 0.280 | 1.535 | 55.7 |
| S18 | Lens | 2.261 | 0.289 | | |
| S19 | Filter | Infinity | 0.210 | 1.517 | 64.2 |
| S20 | | Infinity | 0.653 | | |
| S21 | Imaging | Infinity | | | |
| | Plane | | | | |

In the ninth embodiment, the first lens 910 has a positive refractive power, an object-side surface of the first lens 910 is convex in a paraxial region thereof, and an image-side surface of the first lens 910 is concave in a paraxial region thereof.

The second lens 920 has a negative refractive power, an object-side surface of the second lens 920 is convex in a paraxial region thereof, and an image-side surface of the second lens 920 is concave in a paraxial region thereof.

The third lens 930 has a positive refractive power, an object-side surface of the third lens 930 is convex in a paraxial region thereof, and an image-side surface of the third lens 930 is concave in a paraxial region thereof.

The fourth lens 940 has a positive refractive power, an object-side surface of the fourth lens 940 is concave in a paraxial region thereof, and an image-side surface of the fourth lens 940 is convex in a paraxial region thereof.

The fifth lens 950 has a negative refractive power, an object-side surface of the fifth lens 950 is convex in a paraxial region thereof, and an image-side surface of the fifth lens 950 is concave in a paraxial region thereof.

The sixth lens 960 has a negative refractive power, an object-side surface of the sixth lens 960 is convex in a paraxial region thereof, and an image-side surface of the sixth lens 960 is concave in a paraxial region thereof.

The seventh lens 970 has a positive refractive power, an object-side surface of an seventh lens 970 is convex in a paraxial region thereof, and an image-side surface of the seventh lens 970 is concave in a paraxial region thereof.

The eighth lens 980 has a positive refractive power, and an object-side surface and an image-side surface of the eighth lens 980 are convex in respective paraxial regions thereof.

The ninth lens 990 has a negative refractive power, an object-side surface of the ninth lens 990 is convex in a paraxial region thereof, and an image-side surface of the ninth lens 990 is concave in a paraxial region thereof.

At least one of the third lens 930, the fifth lens 950, the eighth lens 980, and the ninth lens 990 has at least one inflection point on at least one of the object-side surface and the image-side surface thereof.

The surfaces of the first lens 910 to the ninth lens 990 have aspheric coefficients as illustrated in Table 18 below. For example, all of the object-side surfaces and the image-side surfaces of the first lens 910 to the ninth lens 990 are aspherical surfaces.

TABLE 18

| | S1 | S2 | S3 | S4 | S5 | S6 |
|---|---|---|---|---|---|---|
| K | −5.133E−01 | −9.366E+00 | 3.242E+00 | −8.051E+00 | −4.269E+01 | 1.336E+01 |
| A | 6.248E−03 | 4.806E−03 | −4.447E−03 | −6.346E−03 | −8.111E−03 | −1.039E−03 |
| B | −1.558E−02 | 2.494E−03 | −1.555E−03 | 2.527E−02 | 2.898E−03 | −4.177E−02 |
| C | 3.473E−02 | −1.380E−02 | −4.662E−03 | −7.146E−02 | −1.004E−02 | 9.664E−02 |
| D | −4.688E−02 | 2.302E−02 | 1.861E−02 | 1.305E−01 | −1.100E−03 | −1.482E−01 |
| E | 4.197E−02 | −2.229E−02 | −2.663E−02 | −1.577E−01 | 2.312E−02 | 1.461E−01 |
| F | −2.611E−02 | 1.413E−02 | 2.236E−02 | 1.322E−01 | −3.536E−02 | −9.211E−02 |
| G | 1.161E−02 | −6.180E−03 | −1.240E−02 | −7.922E−02 | 2.974E−02 | 3.406E−02 |
| H | −3.735E−03 | 1.915E−03 | 4.763E−03 | 3.451E−02 | −1.629E−02 | −3.856E−03 |
| J | 8.725E−04 | −4.244E−04 | −1.291E−03 | −1.098E−02 | 6.123E−03 | −2.955E−03 |
| L | −1.464E−04 | 6.692E−05 | 2.464E−04 | 2.525E−03 | −1.598E−03 | 1.822E−03 |
| M | 1.718E−05 | −7.342E−06 | −3.244E−05 | −4.096E−04 | 2.850E−04 | −5.124E−04 |
| N | −1.339E−06 | 5.332E−07 | 2.805E−06 | 4.444E−05 | −3.320E−05 | 8.275E−05 |
| O | 6.222E−08 | −2.307E−08 | −1.433E−07 | −2.894E−06 | 2.275E−06 | −7.402E−06 |
| P | −1.304E−09 | 4.507E−10 | 3.275E−09 | 8.547E−08 | −6.956E−08 | 2.857E−07 |

| | S7 | S8 | S9 | S10 | S11 | S12 |
|---|---|---|---|---|---|---|
| K | 2.200E+01 | 1.347E+01 | −8.998E+01 | −2.806E+01 | 3.856E+01 | 3.753E+01 |
| A | 5.604E−04 | 1.773E−02 | 2.376E−02 | 1.960E−02 | −5.696E−03 | 2.075E−02 |
| B | 1.816E−02 | −5.540E−02 | −1.145E−01 | −5.989E−02 | 3.983E−02 | −1.383E−01 |
| C | −8.138E−02 | 5.789E−02 | 1.680E−01 | 3.863E−02 | −1.199E−01 | 2.021E−01 |
| D | 1.787E−01 | −1.187E−02 | −2.124E−01 | −4.310E−04 | 1.696E−01 | −1.924E−01 |
| E | −2.501E−01 | −5.249E−02 | 2.313E−01 | −2.255E−02 | −1.532E−01 | 1.239E−01 |
| F | 2.410E−01 | 8.485E−02 | −1.970E−01 | 2.390E−02 | 9.526E−02 | −5.443E−02 |
| G | −1.662E−01 | −7.155E−02 | 1.244E−01 | −1.479E−02 | −4.188E−02 | 1.656E−02 |
| H | 8.354E−02 | 3.928E−02 | −5.746E−02 | 6.253E−03 | 1.317E−02 | −3.526E−03 |
| J | −3.068E−02 | −1.483E−02 | 1.926E−02 | −1.871E−03 | −2.964E−03 | 5.250E−04 |
| L | 8.141E−03 | 3.891E−03 | −4.626E−03 | 3.969E−04 | 4.732E−04 | −5.374E−05 |
| M | −1.519E−03 | −6.988E−04 | 7.744E−04 | −5.851E−05 | −5.220E−05 | 3.628E−06 |
| N | 1.888E−04 | 8.198E−05 | −8.572E−05 | 5.708E−06 | 3.777E−06 | −1.484E−07 |
| O | −1.402E−05 | −5.664E−06 | 5.634E−06 | −3.319E−07 | −1.609E−07 | 3.031E−09 |
| P | 4.707E−07 | 1.748E−07 | −1.663E−07 | 8.715E−09 | 3.050E−09 | −1.591E−11 |

| | S13 | S14 | S15 | S16 | S17 | S18 |
|---|---|---|---|---|---|---|
| K | 3.681E+01 | 3.792E+01 | −1.032E+01 | −9.897E+01 | 1.846E+01 | −1.054E+01 |
| A | 2.851E−02 | −2.706E−03 | 2.495E−02 | 3.422E−02 | −1.464E−01 | −6.711E−02 |
| B | −1.833E−01 | −9.428E−02 | −3.513E−02 | −2.145E−02 | 6.627E−02 | 2.965E−02 |
| C | 2.731E−01 | 1.314E−01 | 2.396E−02 | 9.936E−03 | −2.107E−02 | −8.931E−03 |
| D | −2.545E−01 | −1.081E−01 | −1.095E−02 | −3.872E−03 | 4.363E−03 | 1.869E−03 |
| E | 1.619E−01 | 6.102E−02 | 3.352E−03 | 1.068E−03 | −5.181E−04 | −2.738E−04 |
| F | −7.185E−02 | −2.465E−02 | −6.953E−04 | −1.888E−04 | 2.120E−05 | 2.845E−05 |
| G | 2.259E−02 | 7.226E−03 | 9.713E−05 | 1.871E−05 | 3.387E−06 | −2.116E−06 |
| H | −5.086E−03 | −1.544E−03 | −8.908E−06 | −3.992E−07 | −6.903E−07 | 1.129E−07 |
| J | 8.235E−04 | 2.397E−04 | 4.948E−07 | −1.500E−07 | 6.330E−08 | −4.274E−09 |
| L | −9.521E−05 | −2.671E−05 | −1.150E−08 | 2.209E−08 | −3.602E−09 | 1.120E−10 |
| M | 7.681E−06 | 2.077E−06 | −4.029E−10 | −1.560E−09 | 1.341E−10 | −1.923E−12 |
| N | −4.112E−07 | −1.069E−07 | 3.912E−11 | 6.346E−11 | −3.194E−12 | 1.930E−14 |
| O | 1.314E−08 | 3.268E−09 | −1.167E−12 | −1.427E−12 | 4.439E−14 | −8.235E−17 |
| P | −1.897E−10 | −4.490E−11 | 1.304E−14 | 1.381E−14 | −2.746E−16 | −5.533E−20 |

The optical imaging system 900 configured as described above may have the aberration characteristics illustrated in FIG. 18.

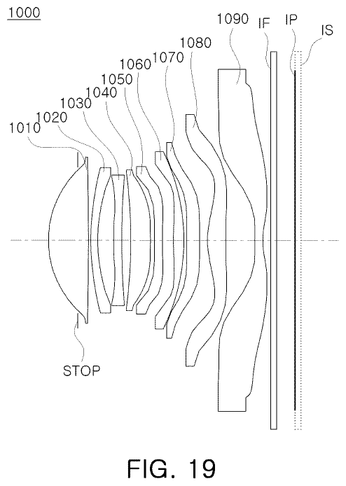

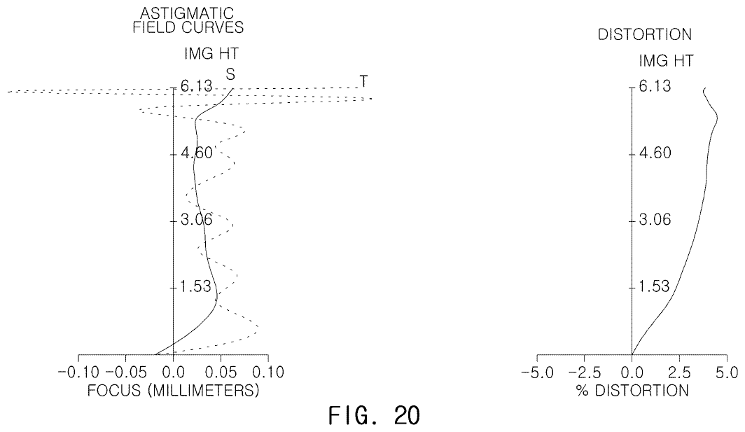

FIG. 19 is a diagram of a configuration of an optical imaging system according to a tenth embodiment, and FIG. 20 is graphs illustrating aberration characteristics of the optical imaging system illustrated in FIG. 19.

Referring to FIG. 19, an optical imaging system 1000 according to the tenth embodiment includes a first lens 1010, a second lens 1020, a third lens 1030, a fourth lens 1040, a fifth lens 1050, a sixth lens 1060, a seventh lens 1070, an eighth lens 1080, and a ninth lens 1090 sequentially disposed in ascending numerical order along an optical axis of the optical imaging system 1000 from an object side of the optical imaging system 1000 toward an imaging plane IP of the optical imaging system 1000, and may further include a filter IF and an image sensor IS disposed after an image-side surface of the ninth lens 1090. The imaging plane IP may be formed on a surface of the image sensor IS.

An aperture STOP may be disposed in front of an object-side surface of the first lens 1010.

The optical imaging system 1000 according to the tenth embodiment may form a focus on the imaging plane IP.

Radiuses of curvature, a thickness between elements, a distance between elements, a refractive index, and an Abbe number of each element of the optical imaging system 1000 are illustrated in Table 19 below.

TABLE 19

| Sur- | | | | Refrac- | |
|---|---|---|---|---|---|
| face | | Radius of | Thickness/ | tive | Abbe |
| No. | Element | Curvature | Distance | Index | Number |
| S1 | First | 3.202 | 1.391 | 1.544 | 56.0 |
| S2 | Lens | 34.499 | 0.050 | | |
| S3 | Second | 9.406 | 0.280 | 1.687 | 18.3 |
| S4 | Lens | 4.713 | 0.560 | | |
| S5 | Third | 8.934 | 0.280 | 1.671 | 19.4 |
| S6 | Lens | 9.591 | 0.333 | | |
| S7 | Fourth | −23.256 | 0.672 | 1.544 | 56.0 |
| S8 | Lens | −8.910 | 0.146 | | |
| S9 | Fifth | 58.730 | 0.280 | 1.614 | 26.3 |
| S10 | Lens | 15.516 | 0.391 | | |
| S11 | Sixth | 22.101 | 0.354 | 1.567 | 37.4 |
| S12 | Lens | 18.131 | 0.070 | | |
| S13 | Seventh | 18.611 | 0.461 | 1.544 | 56.0 |
| S14 | Lens | 19.941 | 0.282 | | |
| S15 | Eighth | 3.820 | 0.668 | 1.544 | 56.0 |
| S16 | Lens | −52.593 | 1.022 | | |
| S17 | Ninth | 25.456 | 0.280 | 1.535 | 55.7 |
| S18 | Lens | 2.260 | 0.289 | | |
| S19 | Filter | Infinity | 0.210 | 1.517 | 64.2 |
| S20 | | Infinity | 0.653 | | |
| S21 | Imaging | Infinity | | | |
| | Plane | | | | |

In the tenth embodiment, the first lens 1010 has a positive refractive power, an object-side surface of the first lens 1010 is convex in a paraxial region thereof, and an image-side surface of the first lens 1010 is concave in a paraxial region thereof.

The second lens 1020 has a negative refractive power, an object-side surface of the second lens 1020 is convex in a paraxial region thereof, and an image-side surface of the second lens 1020 is concave in a paraxial region thereof.

The third lens 1030 has a positive refractive power, an object-side surface of the third lens 1030 is convex in a paraxial region thereof, and an image-side surface of the third lens 1030 is concave in a paraxial region thereof.

The fourth lens 1040 has a positive refractive power, an object-side surface of the fourth lens 1040 is concave in a paraxial region thereof, and an image-side surface of the fourth lens 1040 is convex in a paraxial region thereof.

The fifth lens 1050 has a negative refractive power, an object-side surface of the fifth lens 1050 is convex in a paraxial region thereof, and an image-side surface of the fifth lens 1050 is concave in a paraxial region thereof.

The sixth lens 1060 has a negative refractive power, an object-side surface of the sixth lens 1060 is convex in a paraxial region thereof, and an image-side surface of the sixth lens 1060 is concave in a paraxial region thereof.

The seventh lens 1070 has a positive refractive power, an object-side surface of the seventh lens 1070 is convex in a paraxial region thereof, and an image-side surface of the seventh lens 1070 is concave in a paraxial region thereof.

The eighth lens 1080 has a positive refractive power, and an object-side surface and an image-side surface of the eighth lens 1080 are convex in respective paraxial regions thereof.

The ninth lens 1090 has a negative refractive power, an object-side surface of the ninth lens 1090 is convex in a paraxial region thereof, and an image-side surface of the ninth lens 1090 is concave in a paraxial region thereof.

At least one of the third lens 1030, the fifth lens 1050, the eighth lens 1080, and the ninth lens 1090 has at least one inflection point on at least one of the object-side surface and the image-side surface thereof.

The surfaces of the first lens 1010 to the ninth lens 1090 have aspheric coefficients as illustrated in Table 20 below. For example, all of the object-side surfaces and the image-side surfaces of the first lens 1010 to the ninth lens 1090 are aspherical surfaces.

TABLE 20

| | S1 | S2 | S3 | S4 | S5 | S6 |
|---|---|---|---|---|---|---|
| K | −5.133E−01 | −9.171E+00 | 3.238E+00 | −8.051E+00 | −4.269E+01 | 1.336E+01 |
| A | 6.560E−03 | 4.472E−03 | −3.936E−03 | −6.236E−03 | −9.074E−03 | −8.015E−04 |
| B | −1.747E−02 | 4.097E−03 | −3.982E−03 | 2.374E−02 | 8.941E−03 | −4.272E−02 |
| C | 3.977E−02 | −1.749E−02 | 1.546E−03 | −6.542E−02 | −2.954E−02 | 9.894E−02 |
| D | −5.441E−02 | 2.802E−02 | 8.610E−03 | 1.179E−01 | 3.797E−02 | −1.521E−01 |
| E | 4.911E−02 | −2.667E−02 | −1.582E−02 | −1.411E−01 | −2.889E−02 | 1.510E−01 |
| F | −3.070E−02 | 1.674E−02 | 1.422E−02 | 1.175E−01 | 1.256E−02 | −9.675E−02 |
| G | 1.368E−02 | −7.279E−03 | −8.028E−03 | −7.009E−02 | −1.611E−03 | 3.751E−02 |
| H | −4.406E−03 | 2.246E−03 | 3.070E−03 | 3.045E−02 | −1.534E−03 | −5.795E−03 |
| J | 1.029E−03 | −4.960E−04 | −8.172E−04 | −9.677E−03 | 1.111E−03 | −2.147E−03 |
| L | −1.724E−04 | 7.795E−05 | 1.517E−04 | 2.229E−03 | −3.809E−04 | 1.578E−03 |
| M | 2.021E−05 | −8.520E−06 | −1.925E−05 | −3.627E−04 | 7.926E−05 | −4.612E−04 |
| N | −1.572E−06 | 6.161E−07 | 1.589E−06 | 3.953E−05 | −1.018E−05 | 7.564E−05 |
| O | 7.286E−08 | −2.651E−08 | −7.671E−08 | −2.590E−06 | 7.439E−07 | −6.819E−06 |
| P | −1.523E−09 | 5.146E−10 | 1.635E−09 | 7.701E−08 | −2.374E−08 | 2.643E−07 |

| | S7 | S8 | S9 | S10 | S11 | S12 |
|---|---|---|---|---|---|---|
| K | 2.190E+01 | 1.347E+01 | −8.997E+01 | −2.803E+01 | 3.848E+01 | 3.752E+01 |
| A | 4.512E−04 | 1.778E−02 | 2.396E−02 | 1.956E−02 | −5.738E−03 | 2.084E−02 |
| B | 1.945E−02 | −5.570E−02 | −1.162E−01 | −5.994E−02 | 4.013E−02 | −1.385E−01 |
| C | −8.730E−02 | 5.894E−02 | 1.739E−01 | 3.969E−02 | −1.208E−01 | 2.022E−01 |
| D | 1.935E−01 | −1.398E−02 | −2.238E−01 | −3.401E−03 | 1.714E−01 | −1.924E−01 |
| E | −2.732E−01 | −4.981E−02 | 2.454E−01 | −1.836E−02 | −1.551E−01 | 1.238E−01 |
| F | 2.655E−01 | 8.261E−02 | −2.089E−01 | 2.025E−02 | 9.670E−02 | −5.435E−02 |
| G | −1.845E−01 | −7.030E−02 | 1.316E−01 | −1.266E−02 | −4.264E−02 | 1.652E−02 |
| H | 9.340E−02 | 3.881E−02 | −6.062E−02 | 5.388E−03 | 1.345E−02 | −3.513E−03 |
| J | −3.452E−02 | −1.471E−02 | 2.027E−02 | −1.623E−03 | −3.039E−03 | 5.221E−04 |
| L | 9.211E−03 | 3.875E−03 | −4.855E−03 | 3.466E−04 | 4.872E−04 | −5.328E−05 |
| M | −1.727E−03 | −6.979E−04 | 8.109E−04 | −5.148E−05 | −5.401E−05 | 3.580E−06 |
| N | 2.157E−04 | 8.209E−05 | −8.958E−05 | 5.063E−06 | 3.930E−06 | −1.450E−07 |
| O | −1.609E−05 | −5.685E−06 | 5.877E−06 | −2.968E−07 | −1.686E−07 | 2.891E−09 |
| P | 5.422E−07 | 1.758E−07 | −1.732E−07 | 7.860E−09 | 3.221E−09 | −1.334E−11 |

| | S13 | S14 | S15 | S16 | S17 | S18 |
|---|---|---|---|---|---|---|
| K | 3.680E+01 | 3.792E+01 | −1.032E+01 | −9.897E+01 | 1.846E+01 | −1.054E+01 |
| A | 2.850E−02 | −2.615E−03 | 2.492E−02 | 3.415E−02 | −1.464E−01 | −6.713E−02 |
| B | −1.834E−01 | −9.463E−02 | −3.505E−02 | −2.130E−02 | 6.623E−02 | 2.967E−02 |
| C | 2.736E−01 | 1.321E−01 | 2.388E−02 | 9.775E−03 | −2.103E−02 | −8.936E−03 |
| D | −2.552E−01 | −1.088E−01 | −1.090E−02 | −3.773E−03 | 4.340E−03 | 1.869E−03 |
| E | 1.624E−01 | 6.149E−02 | 3.334E−03 | 1.030E−03 | −5.111E−04 | −2.738E−04 |
| F | −7.217E−02 | −2.487E−02 | −6.904E−04 | −1.786E−04 | 1.983E−05 | 2.844E−05 |
| G | 2.271E−02 | 7.297E−03 | 9.618E−05 | 1.682E−05 | 3.572E−06 | −2.114E−06 |
| H | −5.121E−03 | −1.560E−03 | −8.778E−06 | −1.505E−07 | −7.081E−07 | 1.126E−07 |
| J | 8.302E−04 | 2.425E−04 | 4.819E−07 | −1.734E−07 | 6.452E−08 | −4.261E−09 |
| L | −9.615E−05 | −2.704E−05 | −1.058E−08 | 2.365E−08 | −3.661E−09 | 1.114E−10 |
| M | 7.772E−06 | 2.104E−06 | −4.489E−10 | −1.633E−09 | 1.361E−10 | −1.907E−12 |
| N | −4.170E−07 | −1.084E−07 | 4.065E−11 | 6.568E−11 | −3.238E−12 | 1.902E−14 |
| O | 1.336E−08 | 3.315E−09 | −1.197E−12 | −1.467E−12 | 4.497E−14 | −7.931E−17 |
| P | −1.933E−10 | −4.558E−11 | 1.331E−14 | 1.414E−14 | −2.780E−16 | −6.996E−20 |

The optical imaging system configured 1000 as described above may have the aberration characteristics illustrated in FIG. 20.

Table 21 below lists optical characteristic values of the optical imaging systems 100 to 1000 according to the first to tenth embodiments. In Table 21, f4 is a focal length of the fourth lens, f5 is a focal length of the fifth lens, f6 is a focal length of the sixth lens, f7 is a focal length of the seventh lens, f8 is a focal length of the eighth lens, and f9 is a focal length of the ninth lens.

TABLE 21

| | Emb. 1 | Emb. 2 | Emb. 3 | Emb. 4 | Emb. 5 |
|---|---|---|---|---|---|
| f | 6.605 | 6.614 | 6.616 | 6.653 | 6.648 |
| f1 | 6.479 | 6.464 | 6.464 | 6.438 | 6.439 |
| f2 | −16.313 | −15.906 | −15.896 | −15.325 | −15.330 |
| f3 | −170.738 | −210.697 | −211.209 | −245.106 | −244.564 |
| f4 | 22.914 | 23.328 | 23.339 | 23.508 | 23.509 |
| f5 | −44.705 | −45.209 | −44.966 | −41.452 | −41.215 |
| f6 | −79.954 | −83.924 | −84.665 | −111.771 | −113.251 |
| f7 | 495.671 | 546.764 | 539.172 | 557.297 | 556.849 |
| f8 | 5.738 | 5.817 | 5.846 | 6.186 | 6.179 |
| f9 | −4.268 | −4.302 | −4.321 | −4.503 | −4.506 |
| f23 | −14.814 | −14.712 | −14.705 | −14.368 | −14.370 |
| f67 | −94.825 | −98.556 | −99.820 | −141.236 | −143.579 |
| IMG HT | 6.129 | 6.129 | 6.129 | 6.129 | 6.129 |
| FOV | 83.380 | 83.300 | 83.280 | 82.977 | 83.014 |
| TTL | 8.672 | 8.672 | 8.672 | 8.672 | 8.672 |
| BFL | 1.195 | 1.182 | 1.180 | 1.158 | 1.158 |
| Fno | 1.313 | 1.312 | 1.313 | 1.314 | 1.313 |
| | Emb. 6 | Emb. 7 | Emb. 8 | Emb. 9 | Emb. 10 |
| f | 6.695 | 6.777 | 6.764 | 6.762 | 6.760 |
| f1 | 6.505 | 6.454 | 6.365 | 6.366 | 6.367 |
| f2 | −16.295 | −15.238 | −14.151 | −14.069 | −13.990 |
| f3 | −290.192 | 200.000 | 200.000 | 180.000 | 164.314 |
| f4 | 24.554 | 27.054 | 25.996 | 26.017 | 26.036 |
| f5 | −53.839 | −42.333 | −34.520 | −34.537 | −34.556 |
| f6 | −60.122 | −74.887 | −180.604 | −180.199 | −179.560 |
| f7 | 549.032 | 530.811 | 455.477 | 455.426 | 455.489 |
| f8 | 5.971 | 6.163 | 6.554 | 6.553 | 6.553 |
| f9 | −4.403 | −4.427 | −4.645 | −4.643 | −4.641 |
| f23 | −15.377 | −16.485 | −15.214 | −15.236 | −15.254 |
| f67 | −65.178 | −84.861 | −305.985 | −304.707 | −302.654 |
| IMG HT | 6.129 | 6.129 | 6.129 | 6.129 | 6.129 |
| FOV | 82.500 | 81.900 | 82.040 | 82.070 | 82.100 |
| TTL | 8.672 | 8.672 | 8.673 | 8.672 | 8.672 |
| BFL | 1.175 | 1.169 | 1.153 | 1.152 | 1.152 |
| Fno | 1.313 | 1.313 | 1.313 | 1.310 | 1.310 |

Table 22 below lists values of Conditional Expressions 1 to 14 of the optical imaging systems 100 to 1000 according to the first to tenth embodiments.

TABLE 22

| | Emb. 1 | Emb. 2 | Emb. 3 | Emb. 4 | Emb. 5 |
|---|---|---|---|---|---|
| (TTL/(2 × IMG HT)) × Fno | 0.929 | 0.928 | 0.929 | 0.930 | 0.929 |
| TTL/f | 1.313 | 1.311 | 1.311 | 1.303 | 1.304 |
| f1/f | 0.981 | 0.977 | 0.977 | 0.968 | 0.969 |
| f1/f2 | −0.397 | −0.406 | −0.407 | −0.420 | −0.420 |
| f1/f3 | −0.038 | −0.031 | −0.031 | −0.026 | −0.026 |
| FOV × (IMG HT/f) | 77.371 | 77.192 | 77.150 | 76.442 | 76.533 |
| BFL/f | 0.181 | 0.179 | 0.178 | 0.174 | 0.174 |
| v1 − v2 | 36.6 | 36.6 | 36.6 | 36.6 | 37.7 |
| v3 − v2 | 1.0 | 0.0 | 0.0 | 0.0 | 1.1 |
| v1 − (v5 + v6)/2 | 26.55 | 26.55 | 26.55 | 26.55 | 24.15 |
| TTL/(2 × IMG HT) | 0.707 | 0.707 | 0.707 | 0.707 | 0.707 |
| Fno | 1.313 | 1.312 | 1.313 | 1.314 | 1.313 |
| f23/f1 | −2.286 | −2.276 | −2.275 | −2.232 | −2.232 |
| f23/f2 | 0.908 | 0.925 | 0.925 | 0.938 | 0.937 |
| | Emb. 6 | Emb. 7 | Emb. 8 | Emb. 9 | Emb. 10 |
| (TTL/(2 × IMG HT)) × Fno | 0.929 | 0.929 | 0.929 | 0.927 | 0.927 |
| TTL/f | 1.295 | 1.280 | 1.282 | 1.282 | 1.283 |
| f1/f | 0.972 | 0.952 | 0.941 | 0.941 | 0.942 |
| f1/f2 | −0.399 | −0.424 | −0.450 | −0.452 | −0.455 |
| f1/f3 | −0.022 | 0.032 | 0.032 | 0.035 | 0.039 |
| FOV × (IMG HT/f) | 75.525 | 74.069 | 74.338 | 74.387 | 74.437 |
| BFL/f | 0.176 | 0.172 | 0.170 | 0.170 | 0.170 |
| v1 − v2 | 37.7 | 37.7 | 37.7 | 37.7 | 37.7 |
| v3 − v2 | 1.1 | 1.1 | 1.1 | 1.1 | 1.1 |
| v1 − (v5 + v6)/2 | 33.70 | 33.70 | 24.15 | 24.15 | 24.15 |
| TTL/(2 × IMG HT) | 0.707 | 0.707 | 0.708 | 0.707 | 0.707 |
| Fno | 1.313 | 1.313 | 1.313 | 1.310 | 1.310 |
| f23/f1 | −2.364 | −2.554 | −2.390 | −2.393 | −2.396 |
| f23/f2 | 0.944 | 1.082 | 1.075 | 1.083 | 1.090 |

As set forth above, with an optical imaging system according to an embodiment, a size may be reduced while implementing a high resolution.

While this disclosure includes specific embodiments, it will be apparent after an understanding of the disclosure of this application that various changes in form and details may be made in these embodiments without departing from the spirit and scope of the claims and their equivalents. Descriptions of features or aspects in each embodiment are to be considered as being applicable to similar features or aspects in other embodiments. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens having a positive refractive power;
a second lens having a negative refractive power;
a third lens having a refractive power;
a fourth lens having a positive refractive power;
a fifth lens having a negative refractive power;
a sixth lens having a refractive power;
a seventh lens having a refractive power;
an eighth lens having a refractive power; and
a ninth lens having a refractive power,
wherein the first to ninth lenses are sequentially disposed in ascending numerical order along an optical axis of the optical imaging system from an object side of the optical imaging system toward an imaging plane of the optical imaging system, and
the optical imaging system satisfies 0.9<(TTL/(2×IMG HT))×Fno≤0.95, where TTL is a distance along the optical axis from an object-side surface of the first lens to the imaging plane, IMG HT is one half of a diagonal length of the imaging plane, and Fno is an F-number of the optical imaging system.

2. The optical imaging system of claim 1, wherein a combined focal length of the second and third lenses has a negative value, and the second and third lenses each have an Abbe number less than 21.

3. The optical imaging system of claim 1, wherein the optical imaging system satisfies 0.67<TTL/(2×IMG HT)<0.73.

4. The optical imaging system of claim 1, wherein the optical imaging system satisfies 1.25<Fno<1.35.

5. The optical imaging system of claim 1, wherein the optical imaging system satisfies 0<f1/f<1, where f is a total focal length of the optical imaging system, and f1 is a focal length of the first lens.

6. The optical imaging system of claim 1, wherein the optical imaging system satisfies −1<f1/f2<0, where f1 is a focal length of the first lens, and f2 is a focal length of the second lens.

7. The optical imaging system of claim 1, wherein the optical imaging system satisfies −1<f1/f3<1, where f1 is a focal length of the first lens, and f3 is a focal length of the third lens.

8. The optical imaging system of claim 1, wherein the optical imaging system satisfies −2.6<f23/f1<−2.00, where f23 is a combined focal length of the second and third lenses, and f1 is a focal length of the first lens.

9. The optical imaging system of claim 1, wherein the optical imaging system satisfies 0.89<f23/f2<1.10, where f23 is a combined focal length of the second and third lenses, and f2 is a focal length of the second lens.

10. The optical imaging system of claim 1, wherein the optical imaging system satisfies 1.20<TTL/f<1.35 and 0<BFL/f<0.2, where f is a total focal length of the optical imaging system, and BFL is a distance along the optical axis from an image-side surface of the ninth lens to the imaging plane.

11. The optical imaging system of claim 1, wherein the optical imaging system satisfies 70°<FOV×(IMG HT/f)<80°, where FOV is a field of view of the optical imaging system, and f is a total focal length of the optical imaging system.

12. The optical imaging system of claim 1, wherein the optical imaging system satisfies either one or both of 25<v1−v2<40 and −10<v3−v2<10, where v1 is an Abbe number of the first lens, v2 is an Abbe number of the second lens, and v3 is an Abbe number of the third lens.

13. The optical imaging system of claim 1, wherein the optical imaging system satisfies 15<v1−(v5+v6)/2<40, where v1 is an Abbe number of the first lens, v5 is an Abbe number of the fifth lens, and v6 is an Abbe number of the sixth lens.

14. The optical imaging system of claim 1, wherein each of the first to third lenses has a convex object-side surface in a paraxial region thereof, and a concave image-side surface in a paraxial region thereof.

15. The optical imaging system of claim 1, wherein the sixth lens has a negative refractive power, and the seventh lens has a positive refractive power, and
a combined focal length of the sixth and seventh lenses has a negative value.

16. The optical imaging system of claim 15, wherein the sixth lens has a concave image-side surface in a paraxial region thereof, and the seventh lens has a convex object-side surface in a paraxial region thereof.

17. The optical imaging system of claim 1, wherein the sixth lens has a negative refractive power.

18. The optical imaging system of claim 1, wherein the seventh lens has a positive refractive power.

19. The optical imaging system of claim 1, wherein the eighth lens has a positive refractive power.

20. The optical imaging system of claim 1, wherein the ninth lens has a negative refractive power.
